(19) United States
(12) Patent Application Publication
(10) Pub. No.: US 2003/0169272 A1
(43) Pub. Date: Sep. 11, 2003

(54) Image generation apparatus and method thereof

(76) Inventor: Hidetoshi Nagano, Tokyo (JP)

Correspondence Address: FROMMER LAWRENCE & HAUG LLP, 745 FIFTH AVENUE, NEW YORK, NY, 10151, US

(21) Appl. No.: 10/358,734

(22) Filed: Feb. 5, 2003

(30) Foreign Application Priority Data
Feb. 6, 2002 (JP) 2002-029504

(51) Int. Cl. G09G 5/00

(52) U.S. Cl. 345/582

(57) ABSTRACT

In a texture blend circuit, arithmetic operations are performed on three colors: a texture color (Rt, Gt, Bt, At) produced from a texture mapping circuit for attaching a texture onto a triangle from vertex coordinates of a triangle and texture information; a shading color (Rf, Gf, Bf, Af) from an interpolation circuit; and a texture environment color (Rc, Gc, Bc, Ac), in order to output an output color (Rv, Gv, Bv, Av). The texture blend circuit is provided with a multiplier for multiplying a color information (RGB) component of a texture color and a brightness information (A) component of a shading color, and an adder for adding a color information (RGB) component of a shading color and the color information by the multiplier for each element.

### BACKGROUND OF THE INVENTION

1. Field of the Invention

The present invention relates to an image generation apparatus for calculating color information of a pixel of a display output image and a method thereof using color information obtained from a texture image for each pixel of image data. Specifically, the present invention relates to a computer graphics technology to be used for generating images by a video game machine, a graphics computer, a video device, etc., and particularly relates to a technology which performs realistic representation of a lustrous object in a display image.

2. Description of the Related Art

Computer graphics is used for generating display images by video game machines, graphics computers, and video devices.

Particularly, three-dimensional computer graphics, which reproduces a three-dimensional space numerically in a computer and generates images by shooting processing using a virtual camera, is a technology for generating a shaded and realistic image, and has become a technology which is widely used from shooting for special effect in movies to general home video game machines.

In three-dimensional computer graphics, a three-dimensional world is created numerically in a computer, a numerically represented object is placed in it, and an object color to be displayed in a generated image is determined by performing a shading calculation when illuminated.

When performing a color calculation of an object, lighting processing, which calculates shading from a light source, normal directions of object surfaces, and reflection parameters, and texture mapping processing which attaches images on the object surfaces are performed.

FIG. 1 is a diagram modeling an appearance in which light from a light source is reflected on an object.

As shown in FIG. 1, the light from a light source LS is separated into a specular reflection component MRC which reflects in a line-symmetrical direction to a normal NRM on a surface SFC of an object in accordance with Snell's law, and a diffuse reflection component DRC which is emitted to the outside of the object again after repeating reflections by dye DY in the object.

When observing a surface of an object, the sum of the specular reflection component MRC and the diffuse reflection component DRC is observed as the reflection light, and thus the color of an object surface can be expressed by the sum of the specular reflection component MRC and the diffuse reflection component DRC as shown by the following expression (1).

Also, an expression (2) is an arithmetic expression for calculating the diffuse reflection component DRC of the expression (1).

[Expression 1]

Surface color(Rᵥ, Gᵥ, Bᵥ)=MRC(Rₛ, Gₛ, Bₛ)+DRC(R_{d}, G_{d}, B_{d}) (1)

[Expression 2]

$${R}_{d} = {R}_{od} * {R}_{ld} * ( {L}_{x} * {N}_{x} + {L}_{y} * {N}_{y} + {L}_{z} * {N}_{z} ) \\ {G}_{d} = {G}_{od} * {G}_{ld} * ( {L}_{x} * {N}_{x} + {L}_{y} * {N}_{y} + {L}_{z} * {N}_{z} ) \\ {B}_{d} = {B}_{od} * {B}_{ld} * ( {L}_{x} * {N}_{x} + {L}_{y} * {N}_{y} + {L}_{z} * {N}_{z} ) \qquad ( 2 )$$

Here, (Lx, Ly, Lz) indicates the direction from which the light comes, and (Nx, Ny, Nz) indicates a normal direction of the object. Also, (Rod, God, Bod) indicates the diffuse reflection coefficient of the object surface, and (Rld, Gld, Bld) is a diffuse term of the light source color.

The diffuse reflection component DRC is the light which is reflected such that energy of the incident light is distributed equally in all directions.

Accordingly, it is proportional to the energy amount of the light coming onto a unit area, and thus is expressed as the above-described expression (2).

The following expression (3) is an arithmetic expression for calculating the specular reflection component MRC of the expression (1).

[Expression 3]

$${R}_{s} = {R}_{os} * {R}_{ls} * {( {H}_{x} * {N}_{x} + {H}_{y} * {N}_{y} + {H}_{z} * {N}_{z} )}^{s} \\ {G}_{s} = {G}_{os} * {G}_{ls} * {( {H}_{x} * {N}_{x} + {H}_{y} * {N}_{y} + {H}_{z} * {N}_{z} )}^{s} \\ {B}_{s} = {B}_{os} * {B}_{ls} * {( {H}_{x} * {N}_{x} + {H}_{y} * {N}_{y} + {H}_{z} * {N}_{z} )}^{s} \qquad ( 3 )$$

Here, (Hx, Hy, Hz) is called a half vector, and indicates a direction which halves a light-source direction and a view-point direction. The term (Ros, Gos, Bos) indicates a specular reflection coefficient, and (Rls, Gls, Bls) is a specular surface term of a light source color.

As shown in FIG. 1, the object surface SFC has microscopic irregularities, and their normals have differences.

The character s in the expression (3) denotes a parameter to reflect differences of the normal directions, and if s is large, it indicates that the surface has little irregularities, that is, the surface is smooth, whereas if s is small, it represents that the surface is rough.

However, when the light source LS is in the opposite direction to the normal of an object, both the specular reflection component MRC and the diffuse reflection component DRC become (0, 0, 0).

There is texture mapping processing which adds images to object surfaces in addition to the lighting processing described above.

In texture mapping processing, texture images are not only simply attached to object surfaces, but the images attached to the object surfaces can be modulated by the color information of the above-described lighting processing result, and fixed color information specified in advance and the color information of the lighting processing result can be synthesized into a texture image at a certain synthesis ratio.

For a method for calculating color information of each pixel of a display image based on the texture color obtained from the texture image, the shading color obtained as a result of lighting processing, and a fixed texture environment specified in advance, four types of texture blend methods shown in FIG. 2 is widely used.

Specifically, “REPLACE”, “MODULATE”, “DECAL”, and “BLEND”.

Also, in FIG. 2, (Rf, Gf, Bf, Af) represents a shading color, (Rt, Gt, Bt, At) represents a texture color, (Rc, Gc, Bc, Ac) represents a texture environment color, and (Rv, Gv, Bv, Av) represents an output color individually.

Also, RGB indicates color information, A indicates the alpha value which is used in the alpha test and the alpha blending.

The texture blend methods shown in FIG. 2 are the methods defined by “OpenGL” which is an actual standard interface in computer graphics.

In this regard, “OpenGL” is a graphics library interface formulated based on the original model of Silicon Graphics Inc in the U.S.A., and is currently managed by the OpenGL Architecture Review Board (ARB).

In order to achieve a texture blend circuit implementing the texture blend method shown in FIG. 2, one multiplier and more than one adder-subtractor are needed to calculate each component of the output color, Rv, Gv, and Bv, and one multiplier is needed to calculate components of the output color Av.

In FIGS. 3 and 4, an example is shown of the texture blend circuit capable of performing the texture blend method in FIG. 2.

FIG. 3 is a diagram illustrating one example of the texture blend circuit for calculating the output color Rv, Gv, and Bv.

The texture blend circuit 10 has input selection circuits (MUX) 11 to 14, an adder 15, a multiplier 16, and an adder 17.

Also, in FIG. 3, TXEC indicates a texture environment color, TXC indicates a texture color, and SHDC indicates a shading color individually.

In FIG. 3, the input selection circuit 11 selects one color from RGB components of the texture environment color, the texture color, and (0, 0, 0).

The input selection circuit 12 selects one color from the shading color or (0, 0, 0), and output it.

The adder 15 subtracts an RGB component output from the input selection circuit 12 from an RGB component output from the input selection circuit 11 for each RGB component, and produces it as an input to the multiplier 16.

The multiplier 16 multiplies the output RGB component of the adder 15 and the RGB component selected by the input selection circuit 13, and output it to the adder 17.

The adder 17 adds the output RGB component of the adder 16 and the RGB component selected by the input selection circuit 14, and thus the final output RGB component can be obtained.

FIG. 4 is a diagram illustrating one example of the texture blend circuit for calculating the output color Av.

The texture blend circuit 20 has a multiplier 21, and an input selection circuit 22.

In FIG. 4, the multiplier 21 multiplies an A (brightness information) component of the texture color and an A component of the shading color. The input selection circuit 22 selects one from the A component of the multiplication result of the multiplier 21, the A component of the texture color, and the A component of the shading color, and produces an output A component Av.

By the above, a texture blend circuit implementing all the texture blend methods in FIG. 2 can be achieved by one circuit.

Since a texture blend method is changed by a user selection, it is important that a texture blend circuit can be implemented by one circuit from the aspect of a circuit size.

In such a texture blend circuit, color information of each pixel can be calculated from a texture color, a texture environment color, and a shading color. Among these, an important processing is shading processing of a texture image using a shading color.

Shading processing of a texture image using a shading color is originally divided into a diffuse mapping and a gloss mapping.

The diffuse mapping is processing which replaces (Rod, God, Bod) in the above expression (2) by the color on the texture image.

On the other hand, the gloss mapping is processing which replaces (Ros, Gos, Bos) in the above expression (3) by the color on the texture image.

FIG. 5 is a diagram illustrating a processing overview when performing a diffuse mapping and a gloss mapping.

As shown in FIG. 5(A-1), a texture image called “gloss map” is image data containing specular reflection coefficients (Ros, Gos, Bos) of an object surface.

As shown in FIG. 5(B-1), a texture image called “diffuse map” is image data containing diffuse reflection coefficients (Rod, God, Bod) of an object surface.

As shown in FIGS. 5(A-2), 5(A-3), 5(B-2), and 5(B-3), modulation is performed on these texture images by a white object's specular reflection light and diffuse reflection light to obtain the object's specular reflection component MRC and diffuse reflection component DRC.

The specular reflection light of a white object is represented by the specular reflection component MRC calculated by setting (Ros, Gos, Bos) to white (1, 1, 1) in the above-described expression (3).

Accordingly, as shown in FIG. 5(A-3), by multiplying the specular reflection coefficients in the gloss map and the specular reflection light, the same effect can be obtained as the case where lighting processing is performed after attaching the gloss map.

Similarly, the diffuse reflection light of a white object is represented by the diffuse reflection component DRC calculated by setting (Rod, God, Bod) to white (1, 1, 1) in the above-described expression (2).

Accordingly, as shown in FIG. 5(B-3), by multiplying the diffuse reflection coefficients in the diffuse map and the diffuse reflection light, the same effect can be obtained as the case where lighting processing is performed after attaching the diffuse map.

As described above, by performing modulation of the specular reflection light for gloss map and modulation of the diffuse reflection light for diffuse map, as shown in FIGS. 5(A-3) and 5(B-3), the specular reflection component MRC and the diffuse reflection component DRC after lighting processing of an object, to which the gloss map and the diffuse map are attached, can be obtained.

By adding the specular reflection component image and the diffuse reflection component image for each RGB component, that is, color information, the final output image can be obtained as shown in FIG. 5(C).

As shown in FIG. 4, a specular reflection component and a diffuse reflection component have physically different qualities, and thus a gloss mapping texture image to be used for (Ros, Gos, Bos) of an object and a diffuse mapping texture image to be used for (Rod, God, Bod) are generally not identical.

FIG. 6 is a diagram illustrating a circuit block which concurrently performs gloss mapping processing and diffuse mapping processing as described above.

The circuit block 30 has a texture mapping circuit 31, an interpolation circuit 32, a texture blend circuit 33, a texture mapping circuit 34, an interpolation circuit 35, a texture blend circuit 36, and an adder 37.

In this regard, in FIG. 6, TXI indicates texture information, TXCO indicates texture coordinates, TCO indicates vertex coordinates, TXC indicates a texture color, TXEC indicates a texture environment color, and SHDC indicates a shading color individually.

The circuit block 30 in FIG. 6 simply comprises two systems having the same configuration. The texture mapping circuit 31, the interpolation circuit 32, and the texture blend circuit 33 are used for diffuse mapping processing, and the texture mapping circuit 34, the interpolation circuit 35, and the texture blend circuit 36 are used for gloss mapping processing.

Then, in the adder 37, the colors obtained from the gloss mapping processing and the diffuse mapping processing are added to produce the final output color (Rv, Gv, Bv, Av).

In such a manner, since the circuit block 30 in FIG. 6 simply comprises two systems having the same configuration, the hardware size has become large.

When a plurality of textures are not handled in order to make the hardware size smaller, and thus only the diffuse mapping processing is performed, the hardware of the texture mapping circuit 34 and the texture blend circuit 36 shown in FIG. 6 can be reduced as a circuit block 30A shown in FIG. 7.

For further reduction of hardware of the circuit in FIG. 7, a description is given in Japanese Unexamined Patent Application Publication No. 10-326351 (Document 1).

In the document 1, a description is given that the specular reflection component in lighting processing for a white object is stored in the A component of the vertex color information, and a diffuse reflection component is stored in the RGB component of the vertex color information, and thus the interpolation circuit, which previously required two circuits, can be reduced to one interpolation circuit for RGBA.

Furthermore, in document 1, by making improvements which are equivalent to changing the texture blend circuits 10 and 20 in FIGS. 3 and 4, respectively to the texture blend circuits 10A and 20A in FIGS. 8 and 9, respectively, the interpolation circuit 35 and the adder 37 in the diffuse mapping processing in FIG. 7 are reduced.

The change from FIG. 3 to FIG. 8 is the point that the A component of the shading color, shown by a double line in the figure, is entered into the MUX 14.

The change from FIG. 4 to FIG. 9 is the point that an adder 23 having the A components of the texture color and the shading color as input is added, and the addition result is entered into the MUX 22.

As a result, by storing brightness of the specular reflection component of a white object in the A component, and storing color information of the diffuse reflection component in the RGB component, it has become possible to synthesize the diffuse mapping and the brightness of the specular reflection component.

The circuit size of the interpolation circuit is relatively large as compared with the adder, and thus reduction of the interpolation circuit has a great meaning.

What enables this reduction is a design by which color information, which required two words for the specular reflection component and the diffuse reflection component, can be processed in one word.

However, the specular reflection component in the above-described document 1 is a monochroic brightness signal, and thus it is impossible to process the specular reflection component which is not necessarily monochroic, such as an object coated with vinyl. It is desirable that there is some coloring method for both a diffuse reflection component and a specular reflection component.

Also, the texture blend circuit described in the above document 1 is not valid when performing a gloss mapping and a diffuse mapping at the same time, and thus the circuit size becomes the same as that of the circuit in FIG. 6.

Accordingly, graphics processor, which can improve reality of a display image by performing the gloss mapping and the diffuse mapping at the same time without deteriorating drawing speed using a small-sized circuit, has been demanded.

Gloss mapping is an effective processing method when expressing a surface on which materials having different specular reflection components are scattered, for example, when expressing a ground surface having puddles after rain, or expressing a wall containing metal powder or stones. However, it cannot be used with disregarding a diffuse reflection component completely.

When conducting the gloss mapping effectively by the texture blend processing shown in FIG. 2, it becomes necessary to use a circuit which performs the gloss mapping and the diffuse mapping shown in FIG. 6 at the same time, or to execute processing which performs the gloss mapping and the diffuse mapping individually, and then adds the display images for each pixel.

If there is a graphics processor circuit which can add a diffuse reflection component without using a diffuse mapping and a specular reflection component using a gloss mapping to generate a display image, it becomes possible to express a ground surface having puddles relatively easily.

Accordingly, a graphics processor circuit has been demanded which can process a diffuse reflection component and a specular reflection component on which gloss mapping has been performed without increasing the circuit size or increasing drawing processing time.

Also, another problem is that when synthesizing a shading color obtained as a result of lighting processing and a texture color obtained from a texture image, the load to change the synthesis ratio is great.

The synthesis ratio when synthesizing a shading color and a texture color needs to be produced by changing and using an A value of every pixel in a texture image from the “OpenGL” definition in FIG. 2.

When using a video image for a texture image, or when performing processing for switching from a lighting color to a texture color by changing the synthesis ratio every second, changing the A value of all the pixels of a texture image requires a large load, and thus it is not realistic.

Consequently, a graphics processor has been demanded in which the synthesis ratio can be changed easily without increasing the hardware size.

### SUMMARY OF THE INVENTION

Accordingly, it is a first object of the present invention to provide an image generation apparatus and a method thereof which can generate a display image with high reality by synthesizing a diffuse reflection component which is equivalent to performing a diffuse mapping and a specular reflection component having RGB three components without deteriorating the drawing speed and without increasing a hardware size such as a graphics processor when processing a specular reflection component and a diffuse reflection component separately in order to improve reality of a display image.

It is a second object of the present invention to provide an image generation apparatus and a method thereof which can generate a display image with high reality by synthesizing a specular reflection component which is equivalent to performing a gloss mapping and a diffuse reflection component having RGB three components without deteriorating the drawing speed and without increasing the hardware size such as a graphics processor.

It is a third object of the present invention to provide an image generation apparatus and a method thereof which can achieve a graphics processor capable of processing a diffuse mapping and a gloss mapping concurrently with having a circuit size which is smaller than twice the circuit size of a graphics processor capable of processing one piece of texture mapping.

It is a fourth object of the present invention to provide an image generation apparatus and a method thereof which can achieve a graphics processor capable of easily changing the synthesis ratio in synthesizing a shading color and a texture color without increasing the circuit size.

In order to achieve the above-described objects, according to a first aspect of the present invention, there is provided an image generation apparatus in which color information is obtained from a texture image for each pixel provided with a plurality of element data of image data, and color information of a pixel of display output image is calculated using the obtained color information, the apparatus including: multiplication means for outputting modulated color information which is produced by multiplying the color information obtained from the texture image for the pixel and specific element data out of a plurality of element data given to the pixel; and addition means for adding, for each element, modulated color information by the multiplication means and element data excluding the specific element data out of the plurality of element data.

According to a second aspect of the present invention, there is provided an image generation apparatus in which color information is obtained from a texture image for each pixel provided with a plurality of element data of image data, and color information of a pixel of display output image is calculated using the obtained color information, the apparatus including: subtraction means for outputting first modulated color information produced by subtracting, for each element, element data excluding a specific element data from color information obtained from the texture image; multiplication means for outputting modulated color information produced by multiplying the first modulated color information produced by the subtraction means and specific element data; and addition means for adding, for each element, the second modulated color information produced by the multiplication means and element data excluding the specific element data out of the plurality of element data.

An image generation apparatus according to the second aspect of the present invention may preferably further including: selection means for selecting either element data excluding the specific element data out of the plurality of element data, or element data excluding the specific element data having all zero element in order to be supplied to the subtraction means.

In an image generation apparatus according to the second aspect of the present invention, the specific element data supplied to the multiplication means may be element data which indicates mixture ratio for each pixel of the image data, and element data excluding the specific element supplied to the subtraction means and the addition means is element data which indicates color information for each pixel of the image data.

In an image generation apparatus according to the second aspect of the present invention, the specific element data supplied to the multiplication means may be element data which indicates brightness information for each pixel of the image data, and element data excluding the specific element supplied to the subtraction means and the addition means is element data which indicates color information for each pixel of the image data.

In an image generation apparatus according to the second aspect of the present invention, the specific element data supplied to the multiplication means may be one element data calculated from element data excluding the specific element data of the diffuse reflection light for each pixel of the image data, and element data excluding the specific element supplied to the subtraction means and the addition means is element data of specular reflection light for each pixel of the image data.

In an image generation apparatus according to the second aspect of the present invention, the specific element data supplied to the multiplication means may be one element data calculated from element data excluding the specific element data of the specular reflection light for each pixel of the image data, and element data excluding the specific element supplied to the subtraction means and the addition means is element data of the diffuse reflection light for each pixel of the image data.

In an image generation apparatus according to the second aspect of the present invention, the plurality of element data may preferably be four element data stored in one word, the specific element data supplied to the multiplication means is one element data indicating mixture ratio for each pixel of image data, and three element data excluding the specific element data supplied to the subtraction means and the addition means is three element data indicating color information for each pixel of image data.

Also, in an image generation apparatus according to the second aspect of the present invention, the plurality of element data may preferably be four element data stored in one word, the specific element data supplied to the multiplication means is one element data indicating brightness information for each pixel of image data, and three element data excluding the specific element data supplied to the subtraction means and the addition means is three element data indicating color information for each pixel of image data.

Also, in an image generation apparatus according to the second aspect of the present invention, the plurality of element data may preferably be four element data stored in one word, the specific element data supplied to the multiplication means is one element data calculated from three element data excluding the specific element data of diffuse reflection light for each pixel of image data, and three element data excluding the specific element data supplied to the subtraction means and the addition means is three element data of specular reflection light for each pixel of image data.

Also, in an image generation apparatus according to the second aspect of the present invention, the plurality of element data may preferably be four element data stored in one word, the specific element data supplied to the multiplication means is one element data calculated from three element data excluding the specific element data of specular reflection light for each pixel of image data, and three element data excluding the specific element data supplied to the subtraction means and the addition means is three element data of diffuse reflection light for each pixel of image data.

According to a third aspect of the present invention, there is provided an image generation apparatus in which color information of a pixel of display output image is calculated using color information obtained from a texture image for each pixel of polygon image data, the apparatus including: a first circuit for extracting a texture color to be attached to each point in the polygon based on vertex coordinates, texture coordinates, and texture information; a second circuit for obtaining a shading color of each point in the polygon based on the vertex coordinates and vertex color information; and a third circuit for obtaining an output color by entering the texture information from the first circuit and the shading color information from the second circuit, wherein the third circuit includes: multiplication means for outputting modulated color information produced by multiplying the texture color information and one specific element data out of the plurality of element data included in the shading color information; and addition means for adding, for each element, element data excluding the specific element data out of the plurality of element data and the modulated color information by the multiplication means.

According to a fourth aspect of the present invention, there is provided an image generation apparatus in which color information of pixel of display output image is calculated using color information obtained from a texture image for each pixel of polygon image data, the apparatus including: a first circuit for extracting a texture color to be attached to each point in the polygon based on vertex information, texture coordinates, and texture information; a second circuit for obtaining shading color of each point in the polygon based on vertex coordinates and vertex color information; and a third circuit for obtaining output color by entering the texture information from the first circuit and the shading color information from the second circuit, wherein the third circuit includes: subtraction means for outputting first modulated color information produced by subtracting, for each element, element data excluding one specific element data included in the shading color information from the texture color information; multiplication means for outputting second modulated color information produced by multiplying the first modulated color information by the specific element data included in the shading color information; and addition means for adding, for each element, element data excluding the specific element data out of the plurality of element data included in the texture information or the shading information, and the second modulated color information by the multiplication means.

According to a fifth aspect of the present invention, there is provided an image generation apparatus in which color information of pixel of display output image is calculated using color information obtained from a texture image for each pixel of polygon image data, the apparatus including: a first circuit for extracting a first texture color to be attached to each point in the polygon based on vertex coordinates, first texture coordinates, and first texture information; a second circuit for obtaining a first shading color of each point in the polygon based on the vertex coordinates and the first vertex color information; a third circuit for obtaining a second shading color by entering the first texture color information from the first circuit and the first shading color information from the second circuit; a fourth circuit for extracting the second texture color to be attached to each point in the polygon based on the vertex coordinates, the second texture coordinates, and the second texture information; and a fifth circuit for obtaining an output color by entering the second texture color information from the second circuit and the second shading color information from the third circuit, wherein at least one of the third circuit and the fifth circuit includes: multiplication means for outputting modulated color information produced by multiplying the texture color information by one specific element data out of the plurality of element data included in the shading color information; and addition means for adding, for each element, element data excluding the specific element data out of the plurality of element data and modulated color information by the multiplication means.

According to a sixth aspect of the present invention, there is provided an image generation apparatus in which color information of pixel of display output image is calculated using color information obtained from a texture image for each pixel of polygon image data, the apparatus including: a first circuit for extracting a first texture color to be attached to each point in the polygon based on vertex coordinates, first texture coordinates, and first texture information; a second circuit for obtaining a first shading color of each point in the polygon based on the vertex coordinates and the first vertex color information; a third circuit for obtaining second shading color by entering the first texture color information from the first circuit and the first shading color information from the second circuit; a fourth circuit for extracting the second texture color to be attached to each point in the polygon based on the vertex coordinates, the second texture coordinates, and the second texture information; and a fifth circuit for obtaining output color by entering the second texture color information from the second circuit and the second shading color information from the third circuit, wherein at least one of the third circuit and the fifth circuit includes: subtraction means for outputting first modulated color information produced by subtracting, for each element, element data excluding one specific element data included in the shading color information from the texture color information; multiplication means for outputting second modulated color information produced by multiplying the first modulated color information by the specific element data included in the shading color information; and addition means for adding, for each element, element data excluding the specific element data out of the plurality of element data included in the texture information or the shading information, and the second modulated color information by the multiplication means.

According to a seventh aspect of the present invention, there is provided a method of generating image in which color information is obtained from a texture image for each pixel of image data, and color information of a pixel of display output image is calculated using the obtained color information, the method including: a first step for dividing a plurality of element data given to the pixel into one specific element data and element data excluding the specific element data; a second step for obtaining modulated color information which is produced by multiplying the color information obtained from the texture image for the pixel and specific element data out of a plurality of element data given to the pixel; and a third step for adding, for each element, modulated color information by the multiplication means to element data excluding the specific element data out of the plurality of element data.

According to an eighth aspect of the present invention, there is provided a method of generating image in which color information is obtained from a texture image for each pixel of image data, and color information of pixels of display output image is calculated using the obtained color information, the method including: a first step for dividing a plurality of element data given to the pixel into one specific element data and element data excluding the specific element data; a second step for obtaining the first modulated color information which is produced by subtracting, for each element, element data excluding one specific element data obtained from color information obtained from the texture image; a third step for obtaining the second modulated color information which is produced by the multiplication of the specific element data and the first modulated color information; and a fourth step for adding, for each element, the second modulated color information and element data excluding the specific element data out of the plurality of element data.

By the present invention, for example, when processing a specular reflection component and a diffuse reflection component separately in order to improve reality of a display image, a display image with high reality can be generated by synthesizing a diffuse reflection component which is equivalent to performing a diffuse mapping and a specular reflection component having RGB three components without deteriorating the drawing speed and without increasing the hardware size such as a graphics processor.

Also, a display image with high reality can be generated by synthesizing a specular reflection component which is equivalent to performing a gloss mapping and a diffuse reflection component having RGB three components without deteriorating the drawing speed and without increasing the hardware size such as a graphics processor.

Furthermore, a graphics processor can be achieved which is capable of processing a diffuse mapping and a gloss mapping concurrently with having a circuit size which is smaller than twice the circuit size of a graphics processor capable of processing one piece of texture mapping.

Also, by the present invention, a graphics processor can be achieved which is capable of easily changing the synthesis ratio in synthesizing a shading color and a texture color without increasing the circuit size.

Moreover, a user can select image generation in accordance with an image generation situation without increasing the circuit size.

### BRIEF DESCRIPTION OF THE DRAWINGS

FIG. 1 is a diagram modeling an appearance in which light from a light source is reflected on an object, and is illustrating a reflection model of an object surface;

FIG. 2 is a diagram illustrating a texture blend method defined by “OpenGL”;

FIG. 3 is an example of a circuit achieving RGB component processing of the texture blend method defined by “OpenGL”;

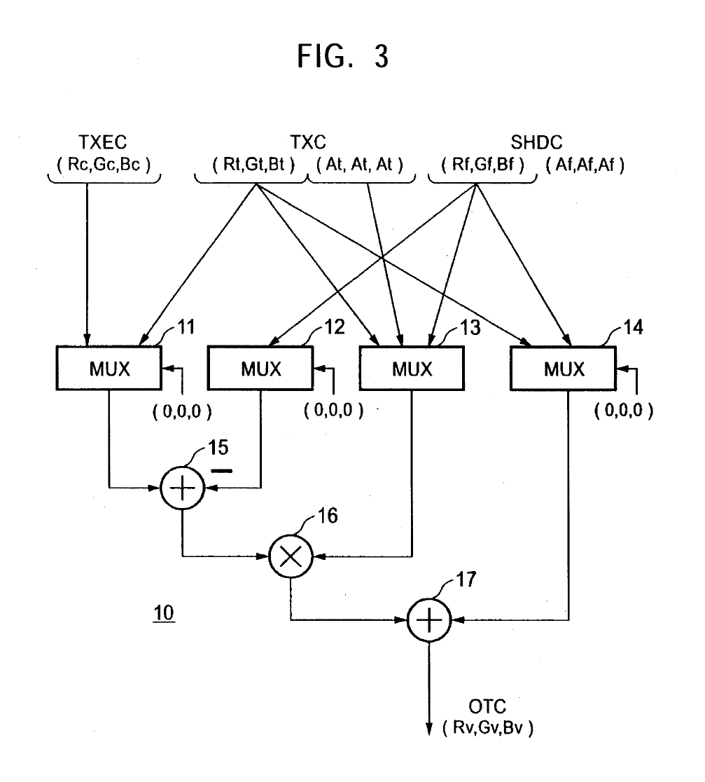

FIG. 4 is an example of a circuit achieving A component processing of the texture blend method defined by “OpenGL”;

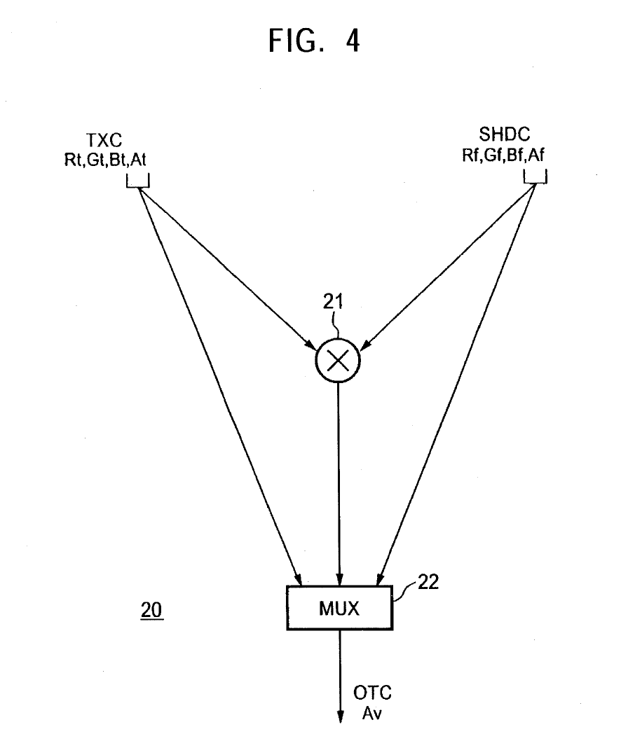

FIG. 5 is a diagram illustrating shading processing using a diffuse mapping and a gloss mapping;

FIG. 6 is a diagram illustrating a circuit which can concurrently perform gloss mapping processing and diffuse mapping processing when using a texture blend circuit conforming to “OpenGL”;

FIG. 7 is an example of a circuit achieving synthesis processing of a specular reflection component and a diffuse reflection component by a diffuse map;

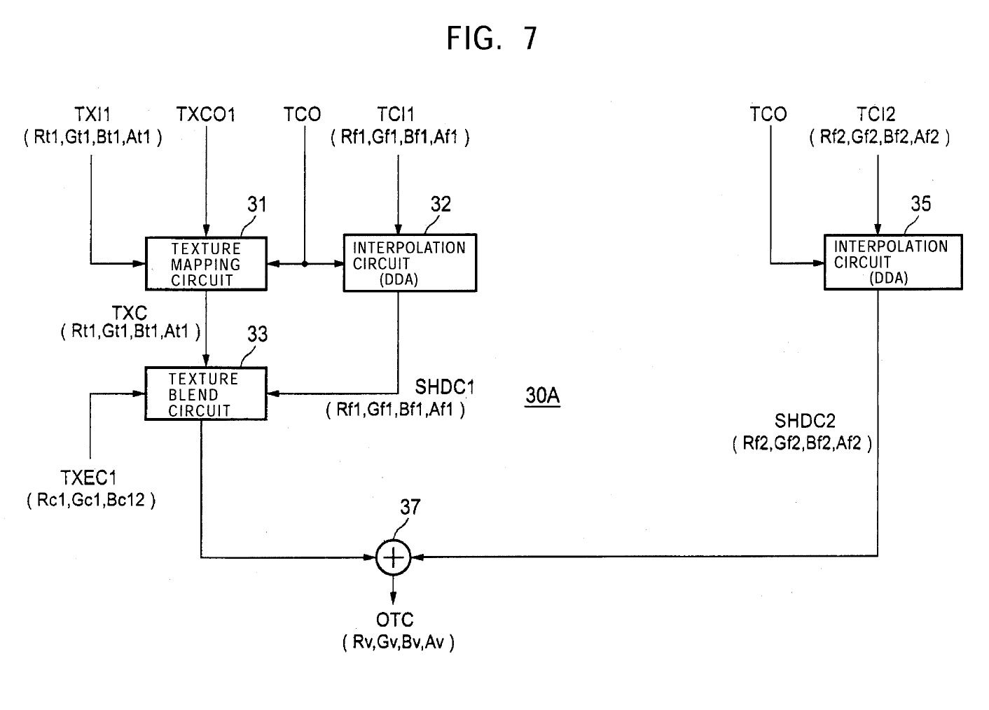

FIG. 8 is a diagram illustrating an example (RGB component) of a texture blend circuit to which the invention described in Japanese Unexamined Patent Application Publication No. 10-326351 is applied;

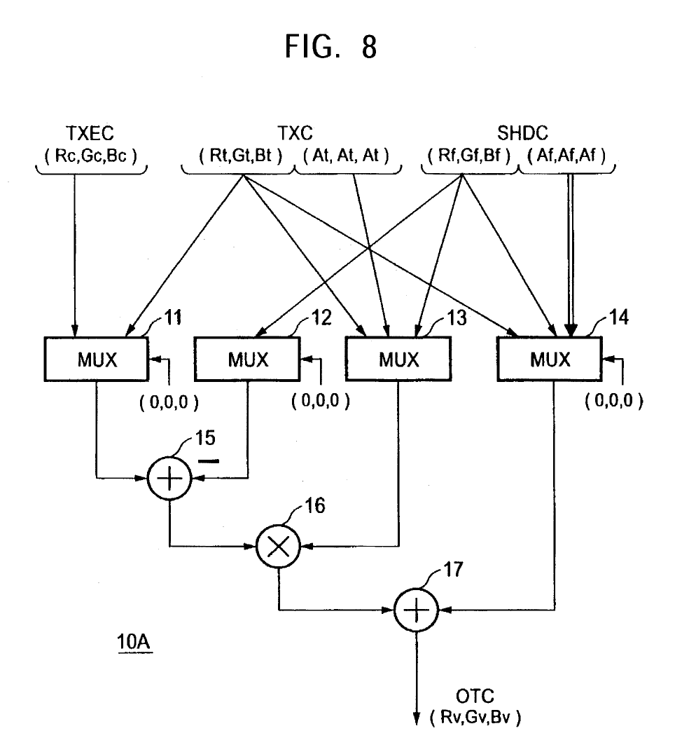

FIG. 9 is a diagram illustrating an example (A component) of a texture blend circuit to which the invention described in Japanese Unexamined Patent Application Publication No. 10-326351 is applied;

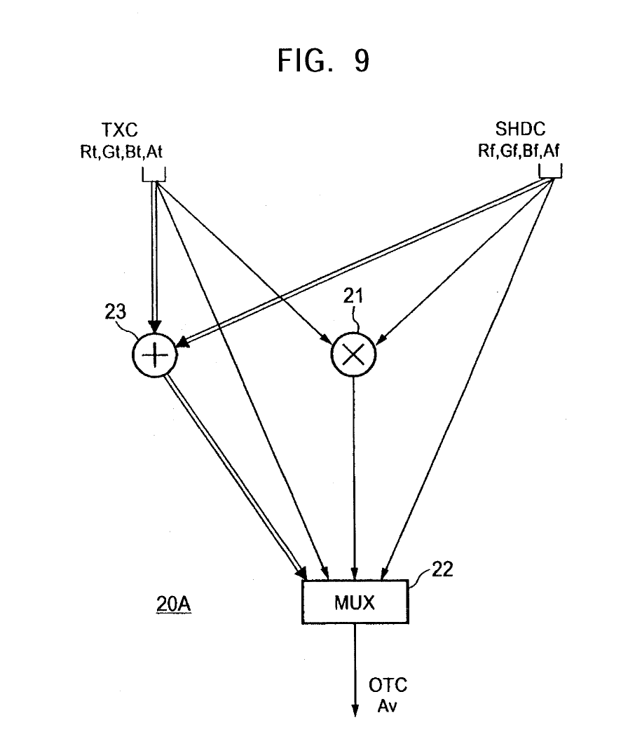

FIG. 10 is a block diagram illustrating an embodiment of an image generation system to which the image generation apparatus according to the present invention is applied, and in which a display image is generated by performing computer graphics processing;

FIG. 11 is a block diagram illustrating a specific configuration example of a graphics processor in the image generation system in FIG. 10;

FIG. 12 is a diagram illustrating an example of a circuit achieving RGB component processing of the texture blend method to which the present invention is applied;

FIG. 13 is a diagram illustrating an example of a circuit achieving A component processing of the texture blend method to which the present invention is applied;

FIG. 14 is a flowchart illustrating steps for performing the diffuse mapping processing according to a first embodiment of the present invention;

FIG. 15 is a flowchart illustrating steps for performing the gloss mapping processing according to a second embodiment of the present invention;

FIG. 16 is a block diagram illustrating a configuration example of a graphics processor which concurrently performs the diffuse mapping processing and the gloss mapping processing according to a third embodiment of the present invention.

FIG. 17 is a flowchart illustrating steps for performing the diffuse mapping processing and the gloss mapping processing according to a third embodiment of the present invention concurrently and in parallel.

FIG. 18 is a flowchart illustrating the steps for performing synthesis processing of a shading color and a texture color in a fourth embodiment of the present invention;

FIG. 19 is a diagram illustrating another example of a circuit for implementing RGB component processing of the texture blend method to which the present invention is applied;

FIG. 20 is a diagram illustrating another example of a circuit for implementing A component processing of the texture blend method to which the present invention is applied; and

FIG. 21 is a diagram illustrating texture blend processing including newly added processing by using the circuits shown in FIGS. 19 and 20.

### DESCRIPTION OF THE PREFERRED EMBODIMENTS

In the following, a description will be given of preferable embodiments of the present invention with reference to the drawings.

First, a description will be given of a system to which the present invention is applied.

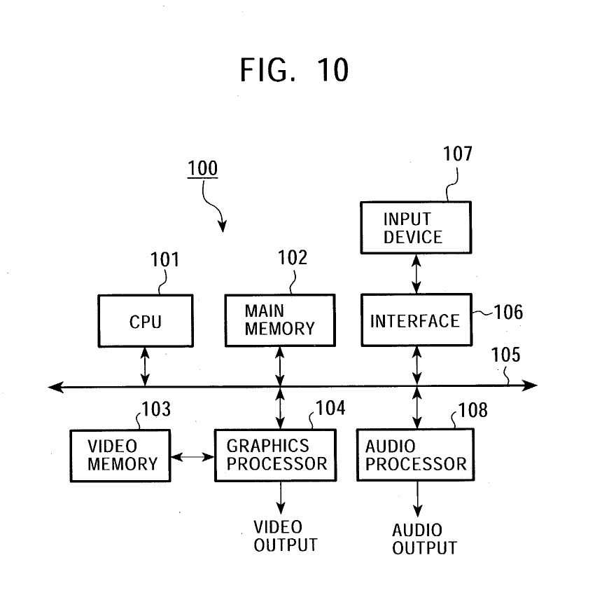

FIG. 10 is a block diagram illustrating an embodiment of an image generation system to which the image generation apparatus according to the present invention is applied, and in which a display image is generated by performing computer graphics processing.

Such an image generation system 100 is a system which is used, for example, for a home video game machine in which three-dimensional image is requested to be displayed with relatively high precision as high speed.

As shown in FIG. 10, the present image generation system 100 has a CPU 101, a main memory 102, a video memory 103, a graphics processor 104, a main bus 105, an interface circuit 106, an input device 107, and an audio processor 108.

The CPU 101 is a central processing unit composed of a microprocessor, etc., and fetches operation information of the input device 107, such as an input pad and a joystick, through the interface circuit 106 and the main bus 105.

The CPU 101 performs coordinate transformation processing of each vertex coordinates, and shading processing of each vertex of the polygon using normals of the polygon faces, a light source direction, and a view point direction on polygon data stored in the main memory 102 for display image generation based on the fetched operation information.

Furthermore, the CPU 101 plays a role of transferring the coordinates, the texture coordinates, the color information (Rf, Gf, Bf, Af) for each vertex of the polygon to the graphics processor 104 through the main bus 105.

In this regard, RGB represents color information, and A generally represents mixture ratio for alpha blend, however, in the present circuit, A is used as brightness information.

The graphics processor 104 is a processor for processing input polygon data to generate image data, and has each of the processing block including a texture blend circuit as described in detail later.

The texture blend circuit according to the present embodiment is an effective circuit in a graphics processor, and performs processing for drawing image data for a display image in the video memory 103.

The image data drawn in the video memory 103 is read when a video signal is scanned, and is displayed on the display unit not shown in FIG. 10.

Also, audio information corresponding to a polygon data used for image data generation together with the above-described image display is transferred from the CPU 101 to the audio processor 108 through the main bus 105.

The audio processor 108 performs reproduction processing on the audio information entered to output audio data.

In this regard, in applying the present invention, audio processing in the system in FIG. 10 is not indispensable, and thus the present invention is valid for an image-display dedicated system without having an audio processor.

In the following, four preferable embodiments, a first to a fourth, of the graphics processor 104 will be described one by one with reference to the drawings.

First Embodiment

The first embodiment is a case of generating a display image having high reality by synthesizing a specular reflection component MRC having RGB three components and a diffuse reflection component DRC which is equivalent to performing a diffuse mapping.

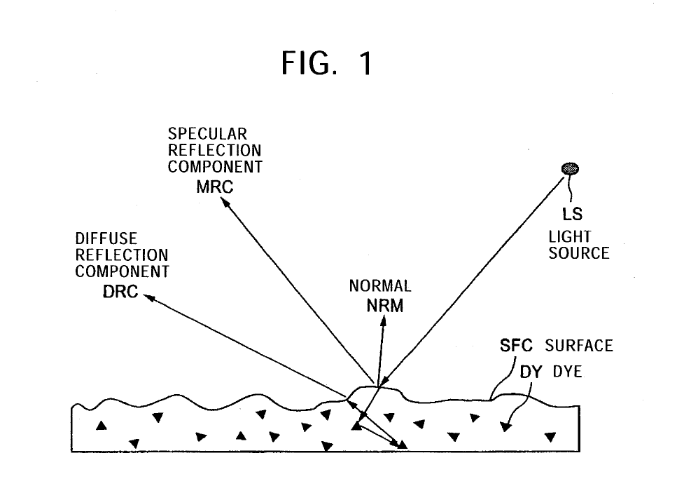

In the first embodiment, reflection on an object surface is taken into consideration of a reflection model shown in FIG. 1. As shown in the above-described expression (1), the surface color of an object is determined by the sum of a diffuse reflection component DRC in the above-described expression (2) and a specular reflection component MRC in the above-described expression (3).

Particularly, the first embodiment is an example of diffuse mapping processing in which the diffuse reflection components (Rod, God, Bod) in the expression (2) are replaced with a texture color of a texture image.

When performing a diffuse mapping, lighting processing is very often performed under a white light source.

In the first embodiment, attention is focused on that point, and thus the diffuse reflection term (Rld, Gld, Bld) of the light source color is set to a monochromic color (Rld Gld=Bld) in the expression (2).

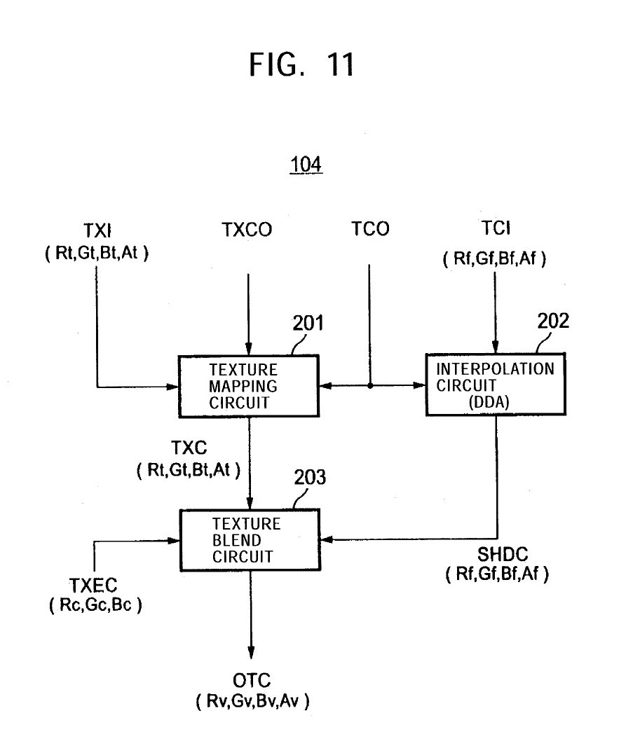

FIG. 11 is a block diagram illustrating a specific configuration example of a graphics processor 104 in the image generation system 100 in FIG. 10.

As shown in FIG. 11, the graphics processor 104 has each of the processing blocks, that is, a texture mapping circuit 201 as a first circuit, an interpolation circuit (DDA: Digital Differential Analyzer) 202 as a second circuit, and a texture blend circuit 203 as a third circuit.

In this regard, in FIG. 11, TXI indicates texture information, TXCO indicates texture coordinates, TCO indicates vertex coordinates, TCI indicates vertex color information, TXC indicates a texture color, TXEC indicates a texture environment color, SHDC indicates a shading color, and OTC indicates an output color individually.

The texture mapping circuit 201 fetches a texture color TXC (Rt, Gt, Bt, At) to be attached to each point in a polygon based on the vertex coordinates TCO, the texture coordinates TXCO, and the texture information TXI which are supplied from the CPU 101 through the main bus 105, and outputs it to the texture blend circuit 203.

The interpolation circuit 202 obtains a shading color SHDC (Rf, Gf, Bf, Af) of each point in the polygon based on the vertex coordinates TCO and the vertex color information TCI which are supplied from the CPU 101 through the main bus 105, and outputs it to the texture blend circuit 203.

The texture blend circuit 203 receives the texture color TXC (Rt, Gt, Bt, At) supplied from the texture mapping circuit 201 and the shading color SHDC (Rf, Gf, Bf, Af) supplied from the interpolation circuit 202 as inputs, performs multiplication for each component of RGB, and obtains the output color OTC (Rv, Gv, Bv, A).

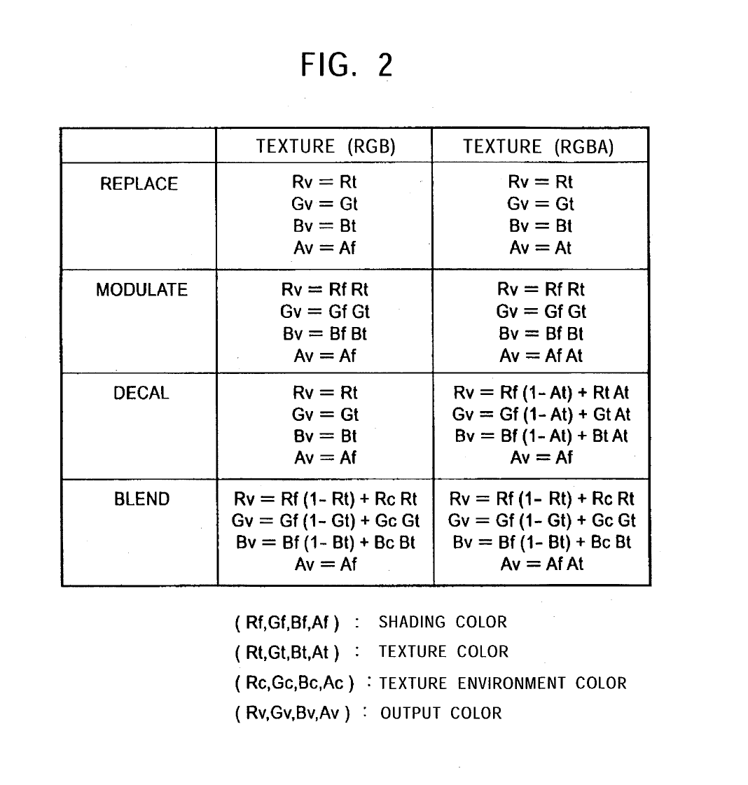

For the texture blend circuit 203, a texture blend method shown in FIG. 2 is defined by the above-described computer graphics standard interface, “OpenGL”.

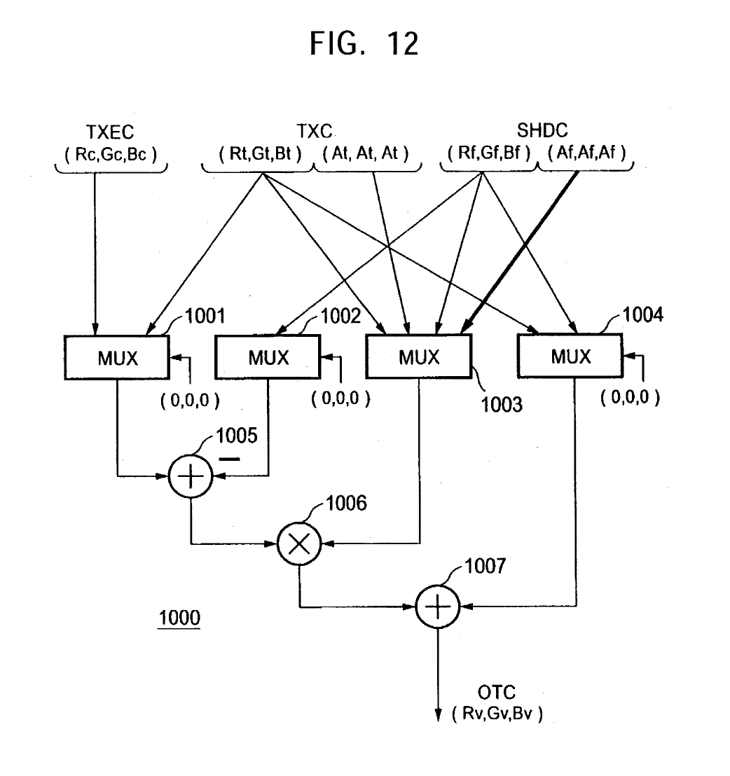

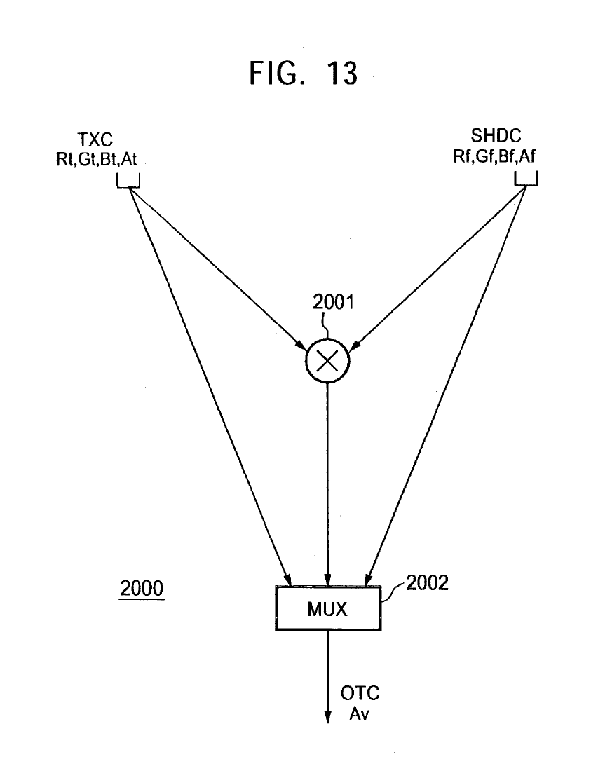

FIGS. 12 and 13 show an example of a texture blend circuit in FIG. 11 according to the first embodiment of the present invention, which can perform a texture blend method in FIG. 2.

FIG. 12 is a diagram illustrating an example of a circuit for calculating the output color OTC (Rv, Gv, Bv) of the texture blend circuit in FIG. 11.

As shown in FIG. 12, the texture blend circuit 1000 has input selection circuits (MUX) 1001 to 1004, an adder 1005 for subtraction means, a multiplier 1006, and an adder 1007.

The input selection circuit 1001 selects one color among a texture environment color TXEC (Rc, Gc, Bc), RGB components (Rt, Gt, Bt) of the texture color TXC, and (0, 0, 0) in accordance with an instruction from the control system not shown in the figure, and outputs it to the adder 1005.

The input selection circuit 1002 selects one color from a shading color SHDC (Rf, Gf, Bf) and (0, 0, 0) in accordance with an instruction from the control system not shown in the figure, and outputs it to the adder 1005.

The input selection circuit 1003 selects one color among RGB components (Rt, Gt, Bt) of the texture color TXC, an A component (At, At, At) of a texture color, a shading color SHDC (Rf, Gf, Bf), and a shading color SHDC (Af, Af, Af) in accordance with an instruction from the control system not shown in the figure, and outputs it to the multiplier 1006.

The input selection circuit 1004 selects one color among RGB components (Rt, Gt, Bt) of the texture color TXC, a shading color SHDC (Rf, Gf, Bf), and (0, 0, 0) in accordance with an instruction from the control system not shown in the figure, and outputs it to the adder 1007.

The adder 1005 subtracts (modulates), for each RGB component, an RGB component output from the input selection circuit 1002 from an RGB component output from the input selection circuit 1001, and outputs first modulated color information to the multiplier 1006.

The multiplier 1006 multiplies (modulates) the output RGB component of the adder 1005 and the RGB component or the A component selected by the input selection circuit 1003, and outputs second modulated color information to the adder 1007.

The adder 1007 adds, for each element, the RGB component and the A component included in the second modulated color information output from the multiplier 1006, and the RGB component selected by the input selection circuit 1004, and by this means, the final output RGB component, that is, the output color OTC (Rv, Gv, Bv) is obtained.

FIG. 13 is a diagram illustrating an example of the circuit for calculating the output color Av of the texture blend circuit in FIG. 11.

The texture blend circuit 2000 has a multiplier 2001 and an input selection circuit 2002.

The multiplier 2001 multiplies the A component of the texture color TXC and the A component of the shading color SHDC, and outputs the result to the input selection circuit 2002.

The input selection circuit 2002 selects one out of the A component of the multiplication result of the multiplier 2001, the A component of the texture color TXC, and the A component of the shading color SHDC, and outputs it as the A component Av.

The above-described texture blend circuit has a bus for inputting the A component Af of the shading color into the input selection circuit 1003 to the multiplier 1006. Thus a display image with high reality can be generated without increasing the hardware size, and lowering the processing speed.

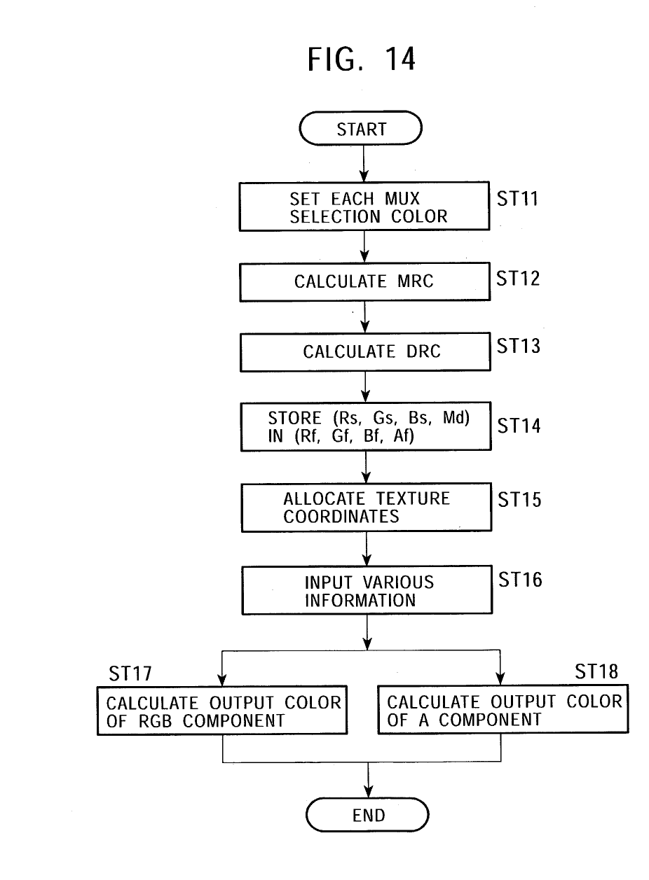

Next, a description will be given of the steps for performing the diffuse mapping processing of the first embodiment using a graphics processor including circuits of FIGS. 12 and 13 as a texture blend circuit with reference to a flowchart in FIG. 14.

Step ST11

First, in step ST11, in order to set a texture blend circuit in FIGS. 12 and 13, in accordance with the instruction of the control system not shown in the figure, a selection color of the input selection circuit 1001 is set to the RGB component (Rt, Gt, Bt) of the texture color TXC, a selection color of the input selection circuit 1002 is set to (0, 0, 0), a selection color of the input selection circuit 1003 is set to the A component (Af, Af, Af) of the shading color SHDC, a selection color of the input selection circuit 1004 is set to the RGB component (Rf, Gf, Bf) of the shading color SHDC, and a selection value of the input selection circuit 2002 is set to the A component Af of the shading color SHDC.

The following processing is performed on each polygon attached to the surface of an object.

Step ST12

In step ST12, a specular reflection component MRC (Rs, Gs, Bs) shown by the above-described expression (3) for each vertex is calculated.

Step ST13

In step ST13, a diffuse reflection component DRC (Rd, Gd, Bd) shown by the above-described expression (2) for each vertex is calculated.

Note that for this calculation, in the expression (2), (Rod, God, Bod) is set to (1, 1, 1), and (Rld, Gld, Bld) is set to, for example, (m, m, m) using the maximum value m of Rld, Gld, and Bld.

As a result, a diffuse reflection component DRC which causes Rd=Gd=Bd=Md can be obtained.

Step ST14

In step ST14, (Rs, Gs, Bs, Md) is stored in the vertex color (Rf, Gf, Bf, Af) individually using the specular reflection component MRC (Rs, Gs, Bs) obtained in step ST12 and the diffuse reflection component Md (=Rd=Gd=Bd) obtained in step ST13.

Step ST15

In step ST15, texture coordinates indicating which pixel in the texture image is referenced is allocated to each vertex.

By performing the above-described steps ST12 to ST15, the vertices of each polygon can have a vertex color having a diffuse reflection component DRC in the Af component and a specular reflection component MRC in Rf, Gf, and Bf, and texture coordinates.

The above-described steps ST12 to ST15 are performed by the CPU 101 in FIG. 10.

Step ST16

For input to the graphics processor 104 in FIG. 11, from the polygon on which the steps ST12 to ST15 are performed, the vertex coordinates TCO, the vertex color information TCI, and the texture coordinates TXCO are input, and for the texture information TXI, a texture image which holds the reflection ratio (Rod, God, Bod) at the time of a diffuse reflection of the object of the above-described expression (2) is input.

The texture image is held in the video memory 103 in FIG. 10, and the texture mapping circuit 201 accesses the video memory 103 as needed, thereby making it possible to obtain a desired texture color TXC.

Also, in the case of the first embodiment of the present invention, a texture environment color TXEC is not used, and thus any value can be used. In this setting, for example, (0, 0, 0) is specified from the CPU 101 to the graphics processor 104.

By the above-described steps, the graphics processor 104 becomes possible for executing, and the texture environment color TXEC, the texture color TXC, and the shading color SHDC are input in the texture blend circuits 1000 and 2000 in FIGS. 12 and 13.

The following processing is performed in FIGS. 12 and 13 by the setting, which has been performed in the above-described step ST11, of the input selection circuits 1001 to 1004 and 2002.

Step ST17

In step ST17, by the adder 1005 of the circuit in FIG. 12, the RGB component (Rt, Gt, Bt) of the texture color TXC selected by the input selection circuit 1001 and (0, 0, 0) selected by the input selection circuit 1002 are added (subtracted).

By the multiplier 1006, (Rt, Gt, Bt) of the output of the adder 1005 and the A component (Af, Af, Af) of the shading color selected by the input selection circuit 1004 are multiplied.

Then by the adder 1007, the output (RtAf, GtAf, BtAf) of the multiplier 1006 and the RGB component (Rf, Gf, Bf) of the shading color SHDC selected by the input selection circuit 1004 are added.

As a result, the output color (Rv, Gv, Bv) by the adder 1007 becomes (RtAf+Rf, GtAf+Gf, BtAf+Bf).

Step ST18

Also, in step ST18, by the multiplier 2001 of the circuit in FIG. 13, an A component At of the texture color TXC and an A component Af of the shading color SHDC are multiplied, and is supplied to the input selection circuit 2002. The input selection circuit 2002 selects the A component Af of the shading color SHDC.

Thus, the output color Av of the circuit in FIG. 13 becomes Af.

In step ST14, a specular reflection component MRC is stored in the RGB component (Rf, Gf, Bf) of the shading color SHDC, and the maximum brightness of the diffuse reflection component DRC for a white object is stored in the A component Af. Thus when taking modulation by the texture color TXC into consideration, a lighting arithmetic expression shown by the following expression (4) is executed.

[Expression 4]

$$\begin{matrix}{R}_{v} = {R}_{td} & * & {M}_{d} & * & ( {L}_{x} * {N}_{x} + {L}_{y} * {N}_{y} + {L}_{z} * {N}_{z} ) + \\ {R}_{os} & * & {R}_{ls} & * & {( {H}_{x} * {N}_{x} + {H}_{y} * {N}_{y} + {H}_{z} * {N}_{z} )}^{s} \\ {G}_{v} = {G}_{td} & * & {M}_{d} & * & ( {L}_{x} * {N}_{x} + {L}_{y} * {N}_{y} + {L}_{z} * {N}_{z} ) + \\ {G}_{os} & * & {G}_{ls} & * & {( {H}_{x} * {N}_{x} + {H}_{y} * {N}_{y} + {H}_{z} * {N}_{z} )}^{s} \\ {B}_{v} = {B}_{td} & * & {M}_{d} & * & ( {L}_{x} * {N}_{x} + {L}_{y} * {N}_{y} + {L}_{z} * {N}_{z} ) + \\ {B}_{os} & * & {B}_{ls} & * & {( {H}_{x} * {N}_{x} + {H}_{y} * {N}_{y} + {H}_{z} * {N}_{z} )}^{s}\end{matrix} \qquad ( 4 )$$

As a result, it has become possible to synthesize the diffuse reflection component DRC produced by performing a diffuse mapping under a white light source and the specular reflection component MRC having RGB three components.

Although it has a limited diffuse mapping, that is, under a white light source, it does not present a big problem, because when shading an object having patterns, a white light source is often used.

Furthermore, by the first embodiment of the present invention, it becomes possible to express gloss by the specular reflection component of the RGB three component with respect to the calculation result of the diffuse reflection component described above.

Moreover, by the first embodiment of the present invention, it becomes possible to generate a display image having high reality by only increasing an input color in the input selection circuit 1003 as shown by the bold solid line in FIG. 12 without virtually increasing an arithmetic unit, without increasing an arithmetic processing time, and without increasing the hardware size and lowering the processing speed.

Second Embodiment

The second embodiment is a case of generating a display image having high reality by synthesizing a diffuse reflection component having RGB three components and a specular reflection component which is equivalent to performing a specular mapping.

In the second embodiment, reflection on an object surface is also taken into consideration of a reflection model shown in FIG. 1. As shown in the above-described expression (1), the surface color of an object is determined by the sum of a diffuse reflection component DRC in the above-described expression (2) and a specular reflection component MRC in the above-described expression (3).

Particularly, the second embodiment is an example of gloss mapping processing in which the specular reflection components (Ros, Gos, Bos) in the expression (3) is replaced with a texture color of a texture image.

When performing a gloss mapping, lighting processing is very often performed under a white light source.

In the second embodiment, attention is focused on that point, and thus the specular reflection term (Rls, Gls, Bls) is set to a monochromic color (Rls=Gls=Bls) in the expression (3).

In the second embodiment of the present invention, as a circuit block of the graphic processor in the image generation system in FIG. 10, a circuit in FIG. 11 is applied in the same manner as the first embodiment. As described above, for the texture blend circuit block, the texture blend method shown in FIG. 2 is defined by the above-described computer graphics standard interface, “OpenGL”.

Also, as a texture blend circuit in FIG. 11 according to the second embodiment of the present invention, the circuits in FIGS. 12 and 13 are applied in the same manner as the first embodiment.

These circuit configurations in FIGS. 11 to 13 are basically the same as those of the first embodiment, and thus the detailed description is omitted here.

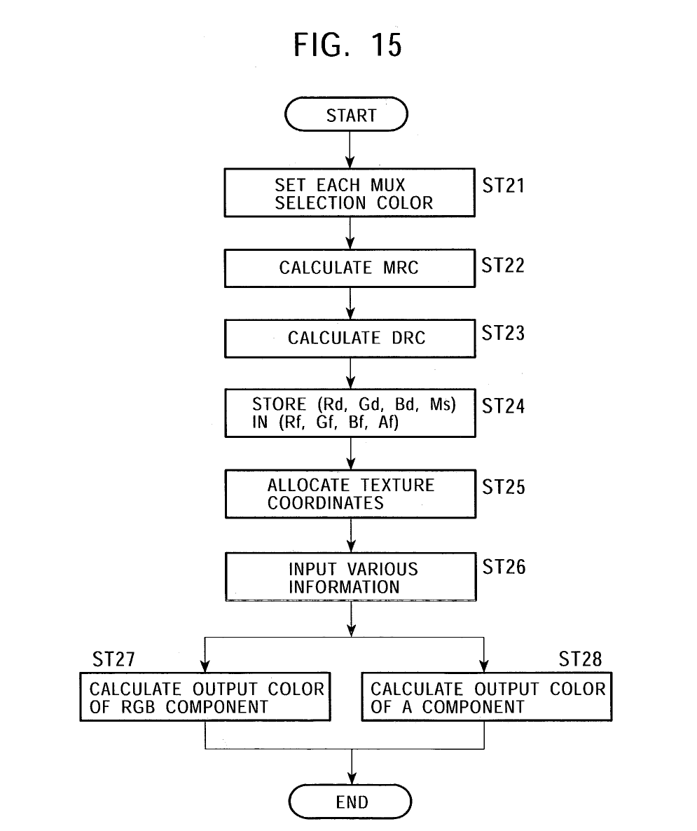

In the following, a description will be given of the steps for performing the gloss mapping processing of the second embodiment using a graphics processor including the circuits of FIGS. 12 and 13 as a texture blend circuit with reference to a flowchart in FIG. 15.

Step ST21

First, in step ST21, in order to set the texture blend circuit in FIGS. 12 and 13, in accordance with the instruction of the control system not shown in the figure, a selection color of the input selection circuit 1001 is set to the RGB component (Rt, Gt, Bt) of the texture color TXC, a selection color of the input selection circuit 1002 is set to (0, 0, 0), a selection color of the input selection circuit 1003 is set to the A component (Af, Af, Af) of the shading color SHDC, a selection color of the input selection circuit 1004 is set to the RGB component (Rf, Gf, Bf) of the shading color SHDC, and a selection value of the input selection circuit 2002 is set to the A component Af of the shading color SHDC.

The following processing is performed on each polygon attached to the surface of an object.

Step ST22

In step ST22, a specular reflection component MRC (Rs, Gs, Bs) shown by the above-described expression (3) for each vertex is calculated.

Note that for this calculation, in the expression (3), (Ros, Gos, Bos) is set to (1, 1, 1), and (Rls, Gls, Bls) is set to, for example, (m, m, m) using the maximum value m of Rls, Gls, and Bls.

As a result, a diffuse reflection component DRC which causes Rs=Gs=Bs=Ms can be obtained.

Step ST23

In step ST23, a diffuse reflection component DRC (Rd, Gd, Bd) shown by the above-described expression (2) for each vertex is calculated.

Step ST24

In step ST24, (Rd, Gd, Bd, Ms) is stored in the vertex color (Rf, Gf, Bf, Af) individually using a diffuse reflection component DRC (Rd, Gd, Bd) obtained in step ST23 and a specular reflection component Ms (=Rs=Gs=Bs) obtained in step ST22.

Step ST25

In step ST25, texture coordinates indicating which pixel in the texture image is referenced is allocated to each vertex.

By performing the above-described steps ST22 to ST25, each vertex of each polygon can have a vertex color having a specular reflection component MRC in the Af component and a diffuse reflection component DRC in Rf, Gf, and Bf, and texture coordinates.

The above-described steps ST22 to ST25 are performed by the CPU 101 in FIG. 10.

Step ST26

For input to the graphics processor 104 in FIG. 11, from the polygon on which the steps ST22 to ST25 are performed, the vertex coordinates TCO, the vertex color information TCI, and the texture coordinates TXCO are input, and for the texture information TXI, a texture image which holds the reflection ratio (Ros, Gos, Bos) at the time of a specular reflection of an object of the above-described expression (3) is input.

The texture image is held in the video memory 103 in FIG. 10, and the texture mapping circuit 201 accesses the video memory 103 as needed, thereby making it possible to obtain a desired texture color TXC.

Also, in the case of the second embodiment of the present invention, a texture environment color TXEC is not used, and thus any value can be used. In this setting, for example, (0, 0, 0) is specified from the CPU 101 to the graphics processor 104.

By the above-described steps, the graphics processor 104 becomes possible for executing, and the texture environment color TXEC, the texture color TXC, and the shading color SHDC are input in the texture blend circuits 1000 and 2000 in FIGS. 12 and 13.

The following processing is performed in FIGS. 12 and 13 by the setting of the input selection circuits 1001 to 1004 and 2002 which has been performed in the above-described step ST21.

Step ST27

In step ST27, by the adder 1005 of the circuit in FIG. 12, the RGB component (Rt, Gt, Bt) of the texture color TXC selected by the input selection circuit 1001, and (0, 0, 0) selected by the input selection circuit 1002 are added (subtracted).

By the multiplier 1006, (Rt, Gt, Bt) of the output of the adder 1005 and the A component (Af, Af, Af) of the shading color selected by the input selection circuit 1004 are multiplied.

Then by the adder 1007, the output (RtAf, GtAf, BtAf) of the multiplier 1006 and the RGB component (Rf, Gf, Bf) of the shading color SHDC selected by the input selection circuit 1004 are added.

As a result, the output color (Rv, Gv, Bv) by the adder 1007 becomes (RtAf+Rf, GtAf+Gf, BtAf+Bf).

Step ST28

Also, in step ST28, by the multiplier 2001 of the circuit in FIG. 13, an A component At of the texture color TXC and an A component Af of the shading color SHDC are multiplied, and is supplied to the input selection circuit 2002. The input selection circuit 2002 selects the A component Af of the shading color SHDC.

Thus, the output color Av of the circuit in FIG. 13 becomes Af.

In step ST24, a diffuse reflection component DRC is stored in the RGB component (Rf, Gf, Bf) of the shading color SHDC, and the maximum brightness of the specular reflection component MRC for a white object is stored in the A component Af. Thus when taking modulation by the texture color TXC into consideration, a lighting arithmetic expression shown by the following expression (5) is executed.

[Expression 5]

$$\begin{matrix}\begin{matrix}{R}_{v} = {R}_{od} * {R}_{ld} * ( {L}_{x} * {N}_{x} + {L}_{y} * {N}_{y} + {L}_{z} * {N}_{z} ) + \\ {R}_{ts} * {M}_{s} * {( {H}_{x} * {N}_{x} + {H}_{y} * {N}_{y} + {H}_{z} * {N}_{z} )}^{s}\end{matrix} & ( 5 ) \\ \begin{matrix}{G}_{v} = {G}_{od} * {G}_{ld} * ( {L}_{x} * {N}_{x} + {L}_{y} * {N}_{y} + {L}_{z} * {N}_{z} ) + \\ {G}_{ts} * {M}_{s} * {( {H}_{x} * {N}_{x} + {H}_{y} * {N}_{y} + {H}_{z} * {N}_{z} )}^{s}\end{matrix} & \\ \begin{matrix}{B}_{v} = {B}_{od} * {B}_{ld} * ( {L}_{x} * {N}_{x} + {L}_{y} * {N}_{y} + {L}_{z} * {N}_{z} ) + \\ {B}_{ts} * {M}_{s} * {( {H}_{x} * {N}_{x} + {H}_{y} * {N}_{y} + {H}_{z} * {N}_{z} )}^{s}\end{matrix} & \end{matrix}$$

As a result, it has become possible to synthesize the specular reflection component MRC produced by performing a gloss mapping under a white light source and the diffuse reflection component DRC having RGB three components.

A gloss mapping is a very effective processing method when expressing a surface on which a specular reflection component MRC varies depending on a position, for example, when expressing a ground surface having puddles after rain, however, in the case of a ground surface, a diffuse reflection component DRC for expressing a soil color is needed in addition to the specular reflection component MRC.

In the second embodiment, as shown in the expression (5), a result of the addition of the diffuse reflection component DRC having RGB three components can be output in addition to the specular reflection component MRC by a gloss mapping. Thus the above-described ground surface having puddles is a preferable example in which the expression power can be improved by applying the present invention.

Moreover, by the second embodiment of the present invention, in the same manner as in the case of the first embodiment, it is possible to generate a display image having high reality by only increasing input color in the input selection circuit 1003 as shown by the bold solid line in FIG. 12 without virtually increasing an arithmetic unit, without increasing a arithmetic processing time, and without increasing the hardware size and lowering the processing speed.

Third Embodiment

The third embodiment is a case in which the present invention is applied to a graphics processor which concurrently processes the diffuse mapping and the gloss mapping.

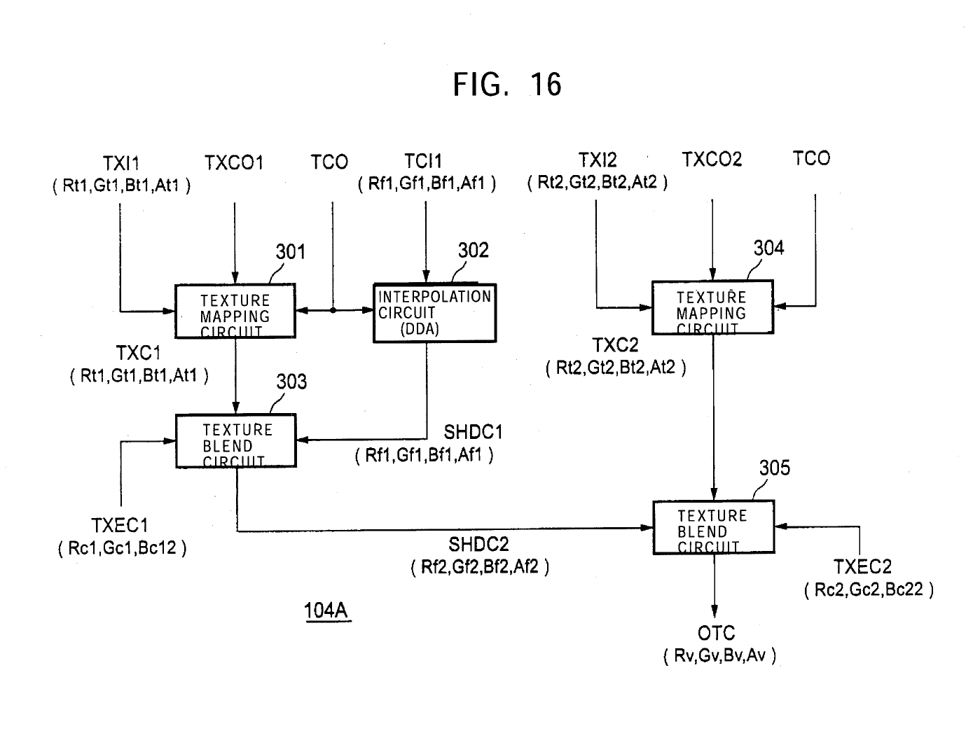

FIG. 16 is a block diagram illustrating a configuration example of a graphics processor in which the diffuse mapping and the gloss mapping according to the third embodiment are concurrently processed.

As shown in FIG. 16, the graphics processor 104A according to the third embodiment has a first texture mapping circuit 301 as a first circuit, an interpolation circuit (DDA) 302 as a second circuit, a first texture blend circuit 303 as a third circuit, a second texture mapping circuit 304 as a fourth circuit, and a second texture blend circuit 305 as a fifth circuit.

In this regard, in FIG. 16, TXI1 indicates texture information 1, TXI2 indicates texture information 2, TXCO1 indicates texture coordinates 1, TXCO2 indicates texture coordinates 2, TCO indicates vertex coordinates, TCI1 indicates vertex color information 1, TXC1 indicates a texture color 1, TXC2 indicates a texture color 2, TXEC1 indicates a texture environment color 1, TXEC2 indicates a texture environment color 2, SHDC1 indicates a shading color 1, SHDC2 indicates a shading color 2, and OTC indicates an output color individually.

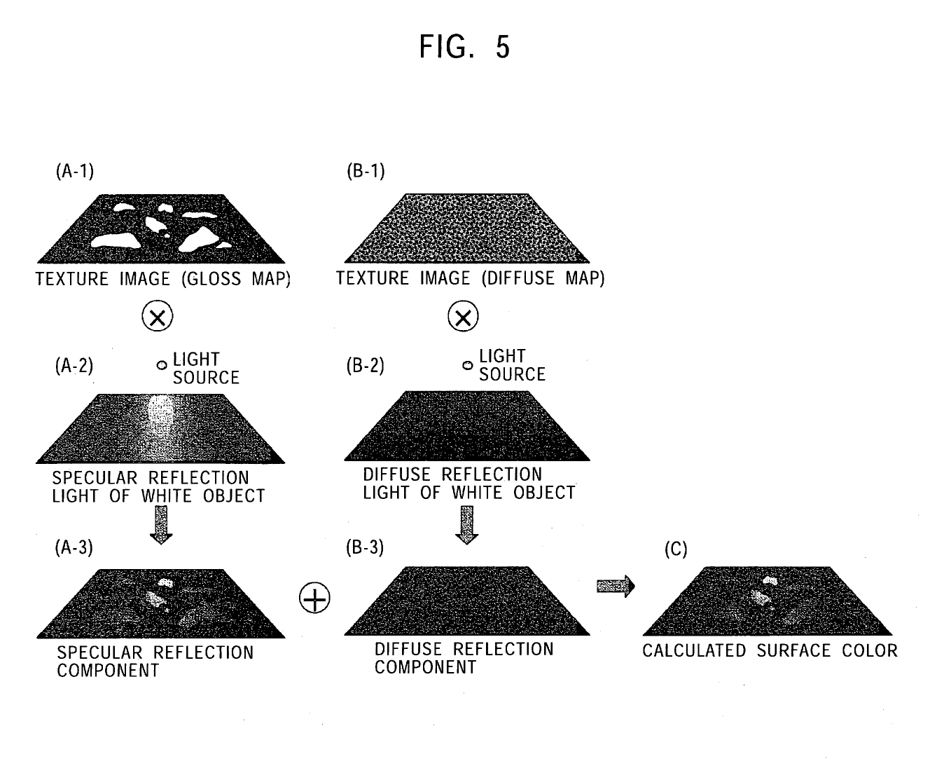

When performing the diffuse mapping and the gloss mapping shown in FIG. 5 concurrently and in parallel, at least two blocks of the texture mapping circuit blocks shown in FIG. 11 are necessary.

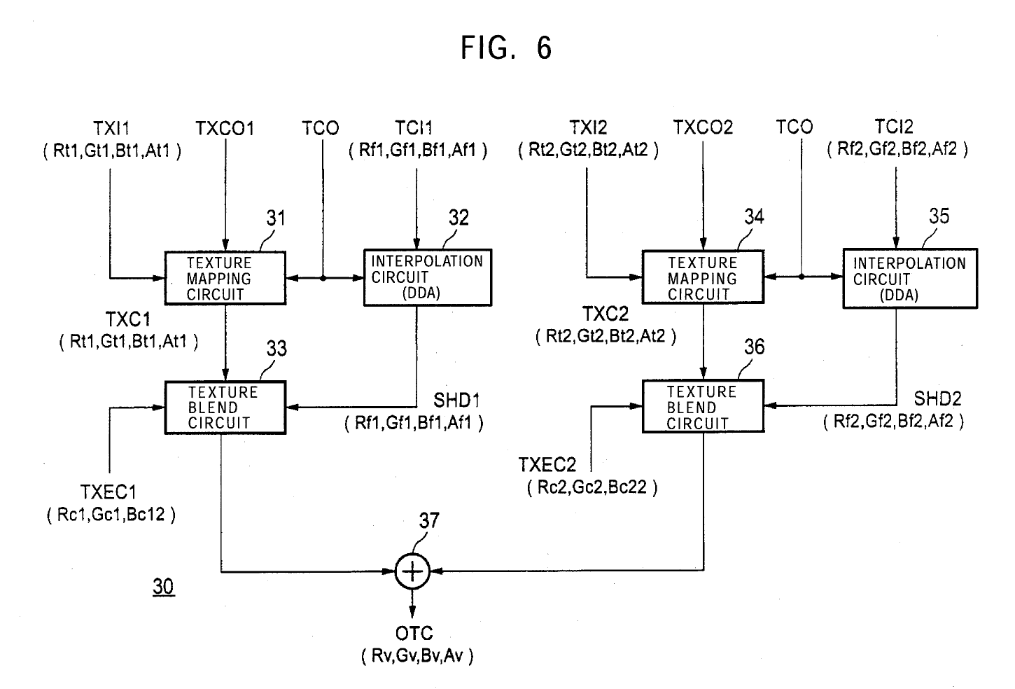

Also, when concurrently processing the diffuse mapping and the gloss mapping by causing the texture blend method in the texture blend circuit block in FIG. 11 to meet the above-described “OpenGL”, which is a standard interface in computer graphics, a graphics processor having a circuit block configuration shown in FIG. 6 becomes necessary.

However, the graphics processor 104A, in FIG. 16, according to the third embodiment achieves the diffuse mapping and the gloss mapping by an equivalent circuit configuration to the configuration in which the interpolation circuit 35 and the adder 37 in FIG. 6 have been removed.

Also, in the third embodiment, the texture information 1, the texture coordinates 1, and the vertex color information 1 deal with a diffuse reflection component, and the texture information 2 and the texture coordinates 2 deal with a specular reflection component.

For the diffuse reflection component dealt with the vertex color information 1, the result of the calculation is input by setting (Rod, God, Bod) of the expression (2) described above to (1, 1, 1).

The first texture mapping circuit 301 fetches a first texture color TXC1 (Rt1, Gt1, Bt1, At1) to be attached to each point in a polygon based on the vertex coordinates TCO, the texture coordinates TXCO1, and the texture information TXI1, which are supplied from the CPU 101 through the main bus 105, and outputs it to the texture blend circuit 303.

The texture information TXI1 stores the texture image to be used for (Rod, God, Bod) of the expression (2).

The interpolation circuit 302 obtains a shading color SHDC1 (Rf1, Gf1, Bf1, Af1) of each point in the polygon by interpolation calculation based on the vertex coordinates TCO and the vertex color information TCI1 which are supplied from the CPU 101 through the main bus 105, and outputs it to the texture blend circuit 303.

The texture blend circuit 303 receives the first texture color TXC1 (Rt1, Gt1, Bt1, At1) supplied from the first texture mapping circuit 301 and the shading color SHDC1 (Rf1, Gf1, Bf1, Af1) supplied from the interpolation circuit 302 as inputs, performs multiplication for each component of RGB, and outputs the result to the second texture blend circuit 305 as the second shading color SHDC2 (Rf2, Gf2, Bf2, Af2) This multiplication processing is called “MODULATE” among the “OpenGL” texture blend processing shown in FIG. 2.

The second texture mapping circuit 304 fetches a second texture color TXC2 (Rt2, Gt2, Bt2, At2) to be attached to each point in a polygon based on the vertex coordinates TCO, the texture coordinates TXCO2, and the texture information TXI2 which are supplied from the CPU 101 through the main bus 105, and outputs it to the texture blend circuit 305.

The texture information TXI2 stores the texture image to be used for (Ros, Gos, Bos) of the expression (3).

The second texture blend circuit 305 receives the second texture color TXC2 (Rt2, Gt2, Bt2, At2) supplied from the second texture mapping circuit 304 and the second shading color SHDC2 (Rf2, Gf2, Bf2, Af2) supplied from the interpolation circuit 303 as inputs, and obtains the output color OTC (Rv, Gv, Bv, Av) by the following expression.

[Expression 6]

$$Rv = Rf2 + Af2 * Rt2 \\ Gv = Gf2 + Af2 * Gt2 \\ Bv = Bf2 + Af2 * Bt2 \\ Av = Af2 \qquad [ Expression 6 ]$$

In this regard, as implementation examples of the first and the second texture blend circuits 303 and 305 according to the third embodiment which can achieve the texture blend method of “OpenGL”, the circuits in FIGS. 12 and 13 are applied in the same manner as the first and the second embodiments.

These circuit configurations in FIGS. 11 to 13 are basically the same as those of the first embodiment, and thus the detailed description is omitted here.

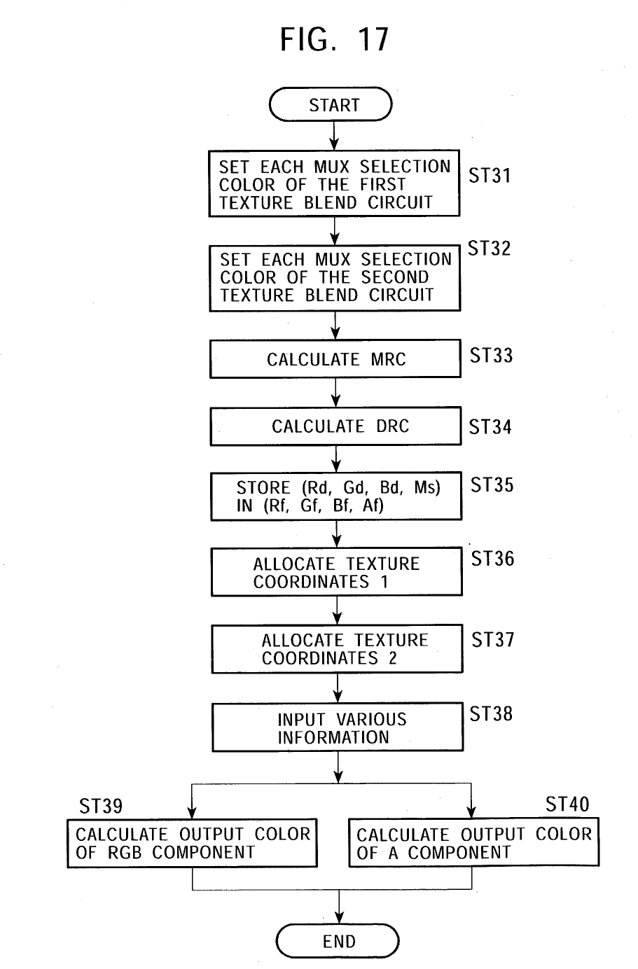

In the following, a description will be given of the steps for performing the diffuse mapping processing and the gloss mapping processing of the third embodiment concurrently in parallel using a graphics processor including the circuits of FIGS. 12 and 13 as the first and the second texture blend circuits with reference to a flowchart in FIG. 17.

Step ST31

First, in step ST31, in order to set the first texture blend circuit 303 in FIGS. 12 and 13, in accordance with the instruction of the control system not shown in the figure, a selection color of the input selection circuit 1001 is set to the RGB component (Rt, Gt, Bt) of the texture color TXC, a selection color of the input selection circuit 1002 is set to (0, 0, 0), a selection color of the input selection circuit 1003 is set to the RGB component (Rf, Gf, Bf) of the shading color SHDC, a selection color of the input selection circuit 1004 is set to (0, 0, 0), and a selection value of the input selection circuit 2002 is set to the A component Af of the shading color SHDC.

By this setting, the output of the texture blend circuit 104A in FIG. 16 becomes a texture color (RtRf, GtGf, BtBf). This is the “MODULATE” processing defined by “QpenGL”.

Step ST32

First, in step ST32, in order to set the second texture blend circuit 305 in FIGS. 12 and 13, in accordance with the instruction of the control system not shown in the figure, a selection color of the input selection circuit 1001 is set to the RGB component (Rt, Gt, Bt) of the texture color TXC, a selection color of the input selection circuit 1002 is set to (0, 0, 0), a selection color of the input selection circuit 1003 is set to the A component (Af, Af, Af) of the shading color SHDC, a selection color of the input selection circuit 1004 is set to (Rf, Gf, Bf), and a selection value of the input selection circuit 2002 is set to the A component Af of the shading color SHDC.

By this setting, the output of the texture blend circuit in FIG. 16 becomes a texture color (RtAf+Rf, GtAf+Gf, BtAf+Bf).

The data to be input into this graphics processor is processed with respect to each polygon attached to the surface of an object in the CPU 101 in the system in FIG. 10. This processing is performed by the processing of the steps ST33 to ST37.

Step ST33

In step ST33, a specular reflection component MRC (Rs, Gs, Bs) shown by the above-described expression (3) for each vertex is calculated.

Note that for this calculation, in the expression (3), (Ros, Gos, Bos) is set to (1, 1, 1), and (Rls, Gls, Bls) is set to, for example, (m, m, m) using the maximum value m of Rls, Gls, and Bls.

As a result, a diffuse reflection component DRC which causes Rs=Gs=Bs=Ms can be obtained.

Step ST34

In step ST34, a diffuse reflection component DRC (Rd, Gd, Bd) shown by the above-described expression (2) for each vertex is calculated.

Step ST35

In step ST35, (Rd, Gd, Bd, Ms) is stored in the vertex color (Rf, Gf, Bf, Af) individually using a diffuse reflection component DRC (Rd, Gd, Bd) obtained in step ST34 and a specular reflection component Ms (=Rs=Gs=Bs) obtained in step ST33.

Step ST36

In step ST36, texture coordinates 1 indicating which pixel in the texture image 1 is referenced is allocated to each vertex.

Step ST37

In step ST37, texture coordinates 2 indicating which pixel in the texture image 2 is referenced is allocated to each vertex.

By performing the above-described steps ST33 to ST37, the vertices of each polygon can have texture coordinates 1 and 2, and a vertex color having a diffuse reflection component DRC in Rf, Gf, and Bf, and a specular reflection component MRC in Af.

Step ST38

For input to the graphics processor 104A in FIG. 16, from the polygon on which the steps ST33 to ST37 are performed, the vertex coordinates TCO, the vertex color information TCI, the texture coordinates TXCO1, and the texture coordinates TXCO2 are input, and for the texture information TXI1, a texture image which holds the reflection ratio (Rod, God, Bod) at the time of a diffuse reflection of an object of the above-described expression (2) is input.

Also, for the texture information TXI2, a texture image which holds the reflection ratio (Ros, Gos, Bos) at the time of a specular reflection of an object of the above-described expression (3) is input.

These texture images 1 and 2 are held in the video memory 103 in FIG. 10, and the first texture blend circuit 303 and the second texture blend circuit 305 in FIG. 16 access the video memory 103 as needed, thereby making it possible to obtain a desired texture color.

Also, in the case of the third embodiment of the present invention, texture environment colors TXEC 1 and TXEC 2 are not used, and thus any value can be used. In this setting, for example, (0, 0, 0) is specified from the CPU 101 to the graphics processor 104A.

By the above-described steps, the graphics processor 104A becomes possible for executing, and the texture environment color TXEC, the texture color TXC, and the shading color SHDC are input in the texture blend circuits 1000 and 2000 in FIGS. 12 and 13.

The following processing is performed in FIGS. 12 and 13 by the setting of the input selection circuits 1001 to 1004 and 2002 which has been performed in the above-described step ST32.

Step ST39

In step ST39, the texture blend circuit 303 in FIG. 16 outputs the color (Rt₁×Rf, Gt₁×Gf, Bt₁×Bf).

And the texture blend circuit 305 in FIG. 16 outputs the color (Rt₁×Rf+Rt₂×Af, Gt₁×Gf+Gt₂×Af, Bt₁×Bf+Bt₂×Af).

Step ST40

In step ST40, the texture blend circuit 303 in FIG. 16 outputs the A component Af.

And the texture blend circuit 305 in FIG. 16 outputs the A component Af.

By the above-described steps, the graphics processor 104A in FIG. 16 becomes possible for executing, and the lighting arithmetic expression shown by the expression (6) described below is executed.

[Expression 7]

$$\begin{matrix}\begin{matrix}{R}_{v} = {R}_{td} * {R}_{ld} * ( {L}_{x} * {N}_{x} + {L}_{y} * {N}_{y} + {L}_{z} * {N}_{z} ) + \\ {R}_{ts} * {M}_{s} * {( {H}_{x} * {N}_{x} + {H}_{y} * {N}_{y} + {H}_{z} * {N}_{z} )}^{s}\end{matrix} & ( 7 ) \\ \begin{matrix}{G}_{v} = {G}_{td} * {G}_{ld} * ( {L}_{x} * {N}_{x} + {L}_{y} * {N}_{y} + {L}_{z} * {N}_{z} ) + \\ {G}_{ts} * {M}_{s} * {( {H}_{x} * {N}_{x} + {H}_{y} * {N}_{y} + {H}_{z} * {N}_{z} )}^{s}\end{matrix} & \\ \begin{matrix}{B}_{v} = {B}_{td} * {B}_{ld} * ( {L}_{x} * {N}_{x} + {L}_{y} * {N}_{y} + {L}_{z} * {N}_{z} ) + \\ {B}_{ts} * {M}_{s} * {( {H}_{x} * {N}_{x} + {H}_{y} * {N}_{y} + {H}_{z} * {N}_{z} )}^{s}\end{matrix} & \end{matrix}$$

As a result, it is possible to synthesize the specular reflection component MRC produced by performing the gloss mapping under a white light source and the diffuse reflection component DRC produced by performing the diffuse mapping. It can be also performed that the RGB component (Rf, Gf, Bf) of the shading color is used as the specular reflection component, texture 1 as gloss map, and the A component (Af) of the sharing color is used as the diffuse reflection brightness and texture 2 as diffuse map.

Moreover, by the third embodiment of the present invention, in the same manner as in the case of the first and second embodiments, it is possible to generate a display image having high reality by only increasing input color in the input selection circuit 1003 as shown by the bold solid line in FIG. 12 without virtually increasing an arithmetic unit, without increasing an arithmetic processing time, and without increasing the hardware size and lowering the processing speed as a matter of course. Also, an interpolation circuit and an adder, which are constituent blocks of graphics processor, can be reduced.

This means that, by the third embodiment, hardware size reduction carried out in FIG. 16 is remarkable as compared with hardware size increase needed for circuit improvement carried out in FIG. 12, and thus effectiveness of the present invention can be confirmed.

Fourth Embodiment

The fourth embodiment is an example in which the present invention is applied to a graphics processor, and a synthesis ratio can be changed easily when synthesizing a shading color and a texture color.

In the fourth embodiment, the A component Af in a shading color is processed simply as a synthesis ratio of a shading color SHDC (Rf, Gf, Bf) and a texture color TXC (Rt, Gt, Bt).

In the fourth embodiment of the present invention, as a circuit block of the graphic processor in the image generation system in FIG. 10, a circuit in FIG. 11 is applied in the same manner as the first and the second embodiments. As described above, for the texture blend circuit block, the texture blend method shown in FIG. 2 is defined by the above-described computer graphics standard interface, “OpenGL”.

Also, as a texture blend circuit in FIG. 11 according to the fourth embodiment of the present invention, the circuits in FIGS. 12 and 13 are applied in the same manner as the first and the second embodiments.

These circuit configurations in FIGS. 11 to 13 are basically the same as those of the first embodiment, and thus the detailed description is omitted here.

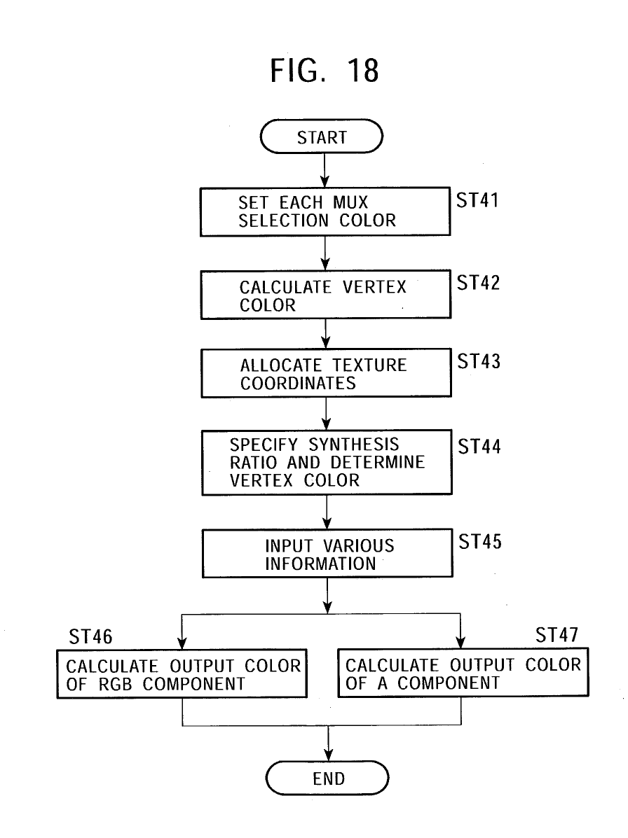

In the following, a description will be given of the steps for performing the gloss mapping processing of the fourth embodiment using a graphics processor including the circuits of FIGS. 12 and 13 as a texture blend circuit with reference to a flowchart in FIG. 18.

Step ST41

First, in step ST41, in order to set the texture blend circuit in FIGS. 12 and 13, in accordance with the instruction of the control system not shown in the figure, a selection color of the input selection circuit 1001 is set to the RGB component (Rt, Gt, Bt) of the texture color TXC, a selection color of the input selection circuit 1002 is set to the RGB component (Rf, Gf, Bf) of the shading color SHDC, a selection color of the input selection circuit 1003 is set to the A component (Af, Af, Af) of the shading color SHDC, a selection color of the input selection circuit 1004 is set to the RGB component (Rf, Gf, Bf) of the shading color SHDC, and a selection value of the input selection circuit 2002 is set to the A component Af of the shading color SHDC.

The following processing is performed on each polygon attached to the surface of an object.

Step ST42

In step ST42, a vertex color (Rf, Gf, Bf) is calculated for each vertex.

This calculation can be done by the color information calculation by the lighting processing given by the above-described expression (1), or can be simply specified for a fixed color.

Step ST43

In step ST43, texture coordinates indicating which pixel in the texture image is referenced is allocated to each vertex.

Step ST44

In step ST44, for each vertex, a synthesis ratio Af for synthesizing a vertex color (Rf, Gf, Bf) and a texture color (Rt, Gt, Bt) obtained from a pixel in a texture image is specified, and a vertex color (Rf, Gf, Bf, Af) is determined.

By performing the above-described steps ST42 to ST44, the vertices of each polygon can have a vertex color having a mixture ratio in the Af component and texture coordinates.

The processing of the steps ST42 to ST44 are performed by the CPU 101 in FIG. 10.

Step ST45

For input to the graphics processor in FIG. 11, from the polygon on which the steps ST42 to ST44 are performed, the vertex coordinates TCO, the vertex color information TCI, and the texture coordinates TXCO are input, and for the texture information TXI, a texture image to be used for synthesis is input.

The texture image is held in the video memory 103 in FIG. 10, and the texture mapping circuit 201 in FIG. 11 accesses the video memory 103 as needed, thereby making it possible to obtain a desired texture color TXC.

Also, in the case of the fourth embodiment of the present invention, a texture environment color TXEC is not used, and thus any value can be used. In this setting, for example, (0, 0, 0) is specified from the CPU 101 to the graphics processor 104.

By the above-described steps, the graphics processor 104 becomes possible for executing, and the texture environment color TXEC, the texture color TXC, and the shading color SHDC are input in the texture blend circuits 1000 and 2000 in FIGS. 12 and 13.

The following processing is performed in FIGS. 12 and 13 by the setting of the input selection circuits 1001 to 1004 and 2002 which has been performed in the above-described step ST41.

Step ST46

In step ST46, by the adder 1005 of the circuit in FIG. 12, the RGB component (Rf, Gf, Bf) of the shading color SHDC selected by the input selection circuit 1002 is subtracted from the RGB component (Rt, Gt, Bt) of the texture color TXC selected by the input selection circuit 1001.

By the multiplier 1006, (Rt−Rf, Gt−Gf, Bt−Bf) of the output of the adder 1005 and the A component (Af, Af, Af) of the shading color selected by the input selection circuit 1004 are multiplied.

Then by the adder 1007, the output (RtAf−RfAf, GtAf−GfAf, BtAf−BfAf) of the multiplier 1006 and the RGB component (Rf, Gf, Bf) of the shading color SHDC selected by the input selection circuit 1004 are added.

As a result, the output color (Rv, Gv, Bv) by the adder 1007 becomes (AfRt+(1−Af)Rf, AfGt+(1−Af)Gf, AfBt+(1−Af)Bf).

Step ST47

Also, in step ST47, by the multiplier 2001 of the circuit in FIG. 13, an A component At of the texture color TXC and an A component Af of the shading color SHDC are multiplied, and is supplied to the input selection circuit 2002. The input selection circuit 2002 selects the A component Af of the shading color SHDC.

Thus, the output color Av of the circuit in FIG. 13 becomes Af.

As a result, the output color (Rv, Gv, Bv) is produced by mixing a texture color TXC and a shading color SHDC at a mixing ration of Af.

Af can be operated easily by the CPU 101, and thus the synthesis ratio can be easily changed.

In “BLEND” of “OpenGL”, the At of a texture image needs to be changed for all pixels, and thus it is not suitable for effect processing of video image which needs to change the synthesis ratio in real time.

Furthermore, when the present invention is applied to the second texture blend circuit 305 of the graphic processor 104A in FIG. 16 which is capable of processing two pieces of texture images, the setting in step ST41 is performed, “REPLACE” processing defined by “OpenGL” is performed by the first texture blend circuit 303, and the RGB component (Rf, Gf, Bf) of the shading color SHD1 input from the interpolation circuit 302 is replaced by the RGB component (Rt1, Gt1, Bt1) of the texture color TXC1, the output color (Rv, Gv, Bv) becomes the color information produced by the mixture of the texture color TXC1 and the texture color TXC2 using the Af1 of the vertex color information TCI1 as a mixture ratio.

This means that the mixture ratio of the texture image 1 and the texture image 2 can be easily operated using Af by the CPU 101.

Switching from a video image 1 to a video image 2 is customary performed by changing the synthesis ratio. Switching from a texture image 1 to a texture image 2 becomes possible by Af which can be easily operated by the CPU 101, and thus switching processing of video images becomes possible easily in the graphics processor.

Moreover, by the fourth embodiment of the present invention, in the same manner as in the case of the first and the second embodiments, it is possible to generate a display image having high reality by only increasing an input color in the input selection circuit 1003 as shown by the bold solid line in FIG. 12 without virtually increasing an arithmetic unit, without increasing an arithmetic processing time, and without increasing the hardware size and lowering the processing speed.

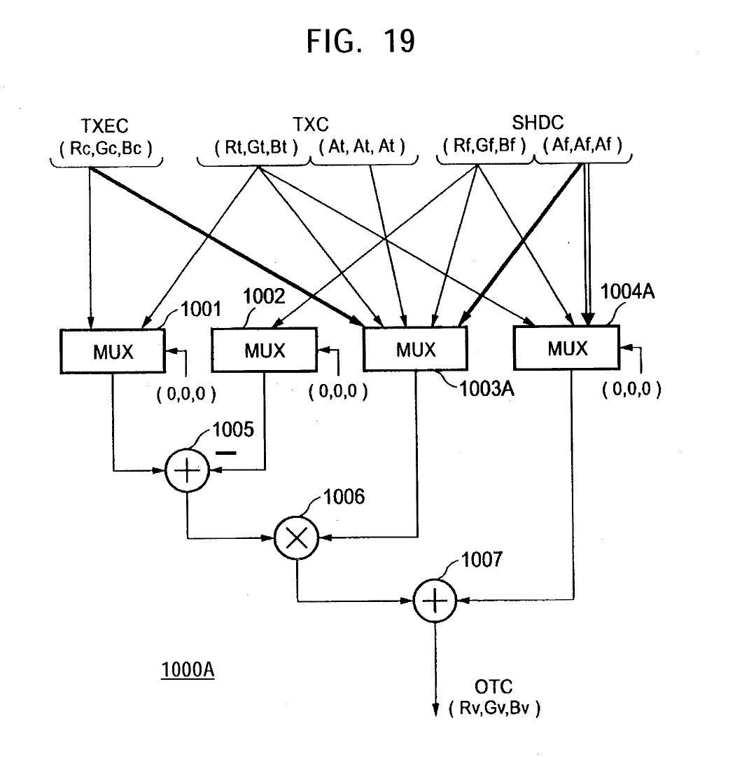

FIG. 19 is a diagram illustrating another example of a circuit for implementing the RGB component processing of the texture blend method to which the present invention is applied.

The difference of the texture blend circuit 1000A from the texture blend circuit 1000 in FIG. 12 is a color selected by the input selection circuit 1003A and the input selection circuit 1004A.

Specifically, in accordance with an instruction from the control system not shown in the figure, the input selection circuit 1003A selects one color among five colors, that is, the colors including the texture environment color TXEC in addition to four colors: RGB components (Rt, Gt, Bt) of the texture color TXC, an A component (At, At, At) of a texture color, a shading color SHDC (Rf, Gf, Bf), and a shading color SHDC (Af, Af, Af), and then outputs it to the multiplier 1006.

Also, in accordance with an instruction from the control system not shown in the figure, the input selection circuit 1004A selects one color among four colors, that is, the colors including the A component Af of the shading color SHDC in addition to three colors: RGB components (Rt, Gt, Bt) of the texture color TXC, a shading color SHDC (Rf, Gf, Bf), and (0, 0, 0), and then outputs it to the adder 1007.

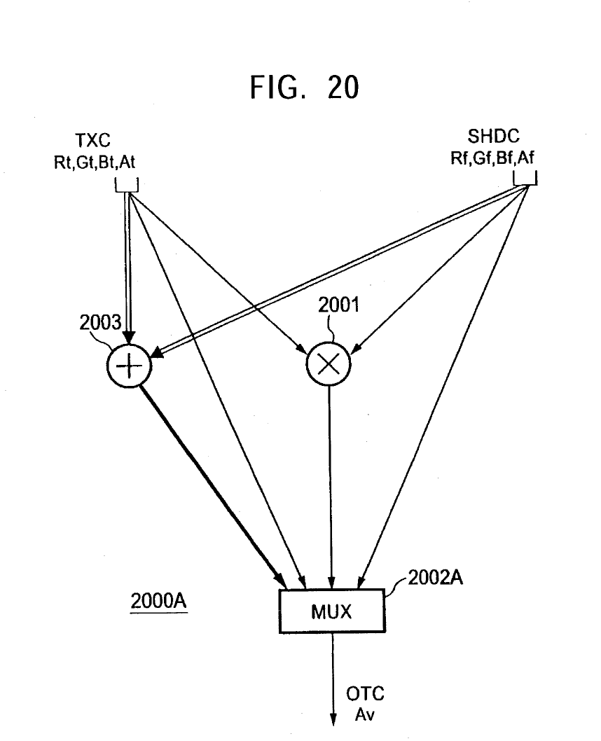

Also, FIG. 20 is a diagram illustrating another example of a texture blend circuit for implementing A component processing of the texture blend method to which the present invention is applied.

The differences of the texture blend circuit 2000A in FIG. 20 from the texture blend circuit 2000 in FIG. 13 are addition of the adder 2003 and a color selected by the input selection circuit 2002A.

Specifically, the adder 2003 adds the A component At of the texture color TXC and the A component Af of the shading color SHDC, and outputs it to the input selection circuit 2002A.

In accordance with an instruction from the control system not shown in the figure, the input selection circuit 2002A selects one color among four colors, that is, the colors including the output AtAf of the adder 2003 in addition to three colors: the A component of the multiplication result of the adder 2001, the A component At of the texture color TXC, and the A component Af of the shading color SHDC, and then output it as the A component Av.

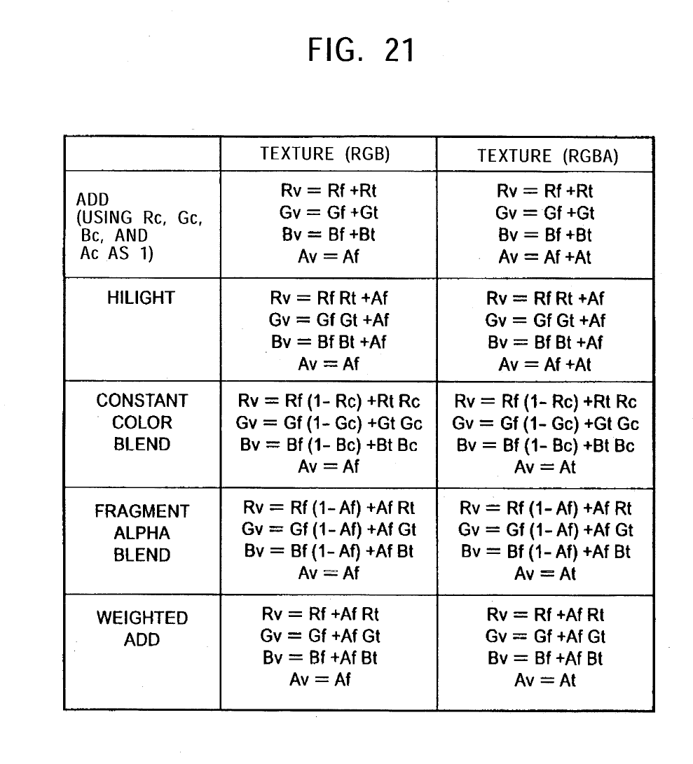

By using the texture blend circuit in FIGS. 19 and 20 having such a configuration, five types of texture blend functions shown in FIG. 21 are added.

Specifically, the five types of texture blend functions are “ADD”, “HILIGHT”, “CONSTANT COLOR BLEND”, “FRAGMENT ALPHA BLEND”, and “WEIGHTED ADD”.

When taking into consideration all the cases for the input selection circuit, texture blend functions are further added, however, it is necessary not to enlarge the circuit size wastefully, because there is a meaningless case where texture is not used at all.

The texture blend functions brought about by the circuit configuration in FIG. 12 according to the present embodiment are represented as “WEIGHTED ADD” and “FRAGMENT ALPHA BLEND”.

In the case of “WEIGHTED ADD”, in the texture blend circuit in FIG. 12, the input selection circuit 1001 selects and outputs the RGB component (Rt, Gt, Bt) of the texture color TXC, the input selection circuit 1002 selects and outputs (0, 0, 0), the input selection circuit 1003 selects and outputs the A component (Af, Af, Af) of the shading color SHDC, and the input selection circuit 1004 selects and outputs the RGB component (Rf, Gf, Bf) of the shading color SHDC.

In the texture blend circuit in FIG. 13, the above function can be executed when the texture image is the RGB component, the input selection circuit 2002 selects and outputs the A component Af of the shading color SHDC, and when the texture image is the RGBA four components, the input selection circuit 2002 selects and outputs the multiplication result of the multiplier 2001.

In the case of “FRAGMENT ALPHA BLEND”, in the texture blend circuit in FIG. 12, the input selection circuit 1001 selects and outputs the RGB component (Rt, Gt, Bt) of the texture color TXC, the input selection circuit 1002 selects and outputs the RGB component (Rf, Gf, Bf), the input selection circuit 1003 selects and outputs the A component (Af, Af, Af) of the shading color SHDC, and the input selection circuit 1004 selects and outputs the RGB component (Rf, Gf, Bf) of the shading color SHDC.

In the texture blend circuit in FIG. 13, the above function can be executed when the texture image is the RGB component, the input selection circuit 2002 selects and outputs the A component Af of the shading color SHDC, and when the texture image is the RGBA four components, the input selection circuit 2002 selects and outputs the multiplication result of the multiplier 2001.

FIGS. 19 and 20 are an example which allows performing various texture blend methods only by enabling selection of arithmetic unit input without increasing the number of arithmetic units. Therefore, the circuit configuration makes it possible to provide many functions while preventing an increase of the hardware size.

As described above, by the present invention, for each pixel of image data, color information from a texture image can be modulated by a plurality of element data provided with each pixel, for example, one element out of four element data stored in a single word, and the modulated texture color and the remaining three element data can be synthesized.

As a result, a specular reflection component and a diffuse reflection component of each pixel of image data can be individually calculated as each RGB three component, and then can be synthesized.

Furthermore, the present invention can be implemented to the multiplication circuit in the texture blend circuit provided with an existing graphics processor by only changing the above-described brightness one component to be allowed to input. Thus the implementation can be done virtually without any increase of hardware.

The present invention has the above qualities, thus when improving reality of a display image by processing a specular reflection component and a diffuse reflection component of an object color, a display image having high reality can be generated by the synthesis of a diffuse reflection component equivalent to a diffuse mapping and a specular reflection component having the RGB three components without lowering a drawing speed and without increasing the hardware size.

Also, a display image having high reality can be generated by the synthesis of a specular reflection component equivalent to a gloss mapping and a diffuse reflection component having the RGB three components without lowering a drawing speed and without increasing the hardware size of the graphics processor.

Furthermore, it becomes possible to compose a graphics processor capable of processing a diffuse mapping and a gloss mapping concurrently with having a circuit size which is smaller than twice the circuit size of a graphics processor capable of processing one piece of texture mapping.

Also, by the present invention, one element out of the four element data in a single word provided for each pixel of image data can be used for a mixture ratio, and thus mixture of a texture color and the remaining three element data can be performed.

This mixture ratio can be easily controlled by the CPU 101 in FIG. 10, and thus a texture color and a shading color can be mixed without changing the A value in a texture image.

When an texture image is a video image, or the mixture ratio changes every second, it is difficult to change the A value in a texture image, and thus the benefit of changing the mixture ratio using the present invention is great.

The entire disclosure of Japanese Patent Application No. 2002-029804 on Feb. 6, 2002 including specification, claims, drawings and summary is incorporated herein by reference in its entirety.

What is claimed is:

1. An image generation apparatus in which color information is obtained from a texture image for each pixel provided with a plurality of element data of image data, and color information of a pixel of display output image is calculated using the obtained color information, the apparatus comprising:
multiplication means for outputting modulated color information which is produced by multiplying the color information obtained from the texture image for the pixel and specific element data out of a plurality of element data given to the pixel; and
addition means for adding, for each element, modulated color information by the multiplication means and element data excluding the specific element data out of the plurality of element data.

2. An image generation apparatus according to claim 1,
wherein the specific element data supplied to the multiplication means is one element data indicating brightness information for each pixel of image data, and
element data excluding the specific element data supplied to the addition means is element data indicating color information for each pixel of image data.

3. An image generation apparatus according to claim 1,
wherein the specific element data supplied to the multiplication means is one element data calculated from element data of diffuse reflection light for each pixel of image data, and
element data excluding the specific element data supplied to the addition means is element data of specular reflection light for each pixel of image data.

4. An image generation apparatus according to claim 1,
wherein the specific element data supplied to the multiplication means is one element data calculated from element data of specular reflection light for each pixel of image data, and
element data excluding the specific element data supplied to the addition means is element data of diffuse reflection light for each pixel of image data.

5. An image generation apparatus according to claim 1,
wherein the plurality of element data is four element data stored in one word,
the specific element data supplied to the multiplication means is one element data indicating brightness information for each pixel of image data, and
three element data excluding the specific element data supplied to the addition means is three element data indicating color information for each pixel of image data.

6. An image generation apparatus according to claim 1,
wherein the plurality of element data is four element data stored in one word,
the specific element data supplied to the multiplication means is one element data calculated from three element data of diffuse reflection light for each pixel of image data, and
three element data excluding the specific element data supplied to the addition means is three element data of specular reflection light for each pixel of image data.

7. An image generation apparatus according to claim 1,
wherein the plurality of element data is four element data stored in one word,
the specific element data supplied to the multiplication means is one element data calculated from three element data of specular reflection light for each pixel of image data, and
three element data excluding the specific element data supplied to the addition means is three element data of diffuse reflection light for each pixel of image data.

8. An image generation apparatus in which color information is obtained from a texture image for each pixel provided with a plurality of element data of image data, and color information of a pixel of display output image is calculated using the obtained color information, the apparatus comprising:
subtraction means for outputting first modulated color information produced by subtracting, for each element, element data excluding a specific element data from color information obtained from the texture image;
multiplication means for outputting modulated color information produced by multiplying the first modulated color information produced by the subtraction means and specific element data; and
addition means for adding, for each element, the second modulated color information produced by the multiplication means and element data excluding the specific element data out of the plurality of element data.

9. An image generation apparatus according to claim 8, further comprising:
selection means for selecting either the element data excluding the specific element data out of the plurality of element data, or element data excluding the specific element data having all zero element in order to be supplied to the subtraction means.

10. An image generation apparatus according to claim 8,
wherein the specific element data supplied to the multiplication means is element data which indicates mixture ratio for each pixel of the image data, and
element data excluding the specific element supplied to the subtraction means and the addition means is element data which indicates color information for each pixel of the image data.

11. An image generation apparatus according to claim 8,
wherein the specific element data supplied to the multiplication means is element data which indicates brightness information for each pixel of the image data, and
element data excluding the specific element supplied to the subtraction means and the addition means is element data which indicates color information for each pixel of the image data.

12. An image generation apparatus according to claim 8,
wherein the specific element data supplied to the multiplication means is one element data calculated from element data of the diffuse reflection light for each pixel of the image data, and
element data excluding the specific element supplied to the subtraction means and the addition means is element data of specular reflection light for each pixel of the image data.

13. An image generation apparatus according to claim 8,
wherein the specific element data supplied to the multiplication means is one element data calculated from element data of the specular reflection light for each pixel of the image data, and
element data excluding the specific element supplied to the subtraction means and the addition means is element data of the diffuse reflection light for each pixel of the image data.

14. An image generation apparatus according to claim 8,
wherein the plurality of element data is four element data stored in one word,
the specific element data supplied to the multiplication means is one element data indicating mixture ratio for each pixel of image data, and
three element data excluding the specific element data supplied to the subtraction means and the addition means is three element data indicating color information for each pixel of image data.

15. An image generation apparatus according to claim 8,
wherein the plurality of element data is four element data stored in one word,
the specific element data supplied to the multiplication means is one element data indicating brightness information for each pixel of image data, and
three element data excluding the specific element data supplied to the subtraction means and the addition means is three element data indicating color information for each pixel of image data.

16. An image generation apparatus according to claim 8,
wherein the plurality of element data is four element data stored in one word, the specific element data supplied to the multiplication means is one element data calculated from
three element data of diffuse reflection light for each pixel of image data, and three element data excluding the specific element data supplied to the subtraction means and the addition means is three element data of specular reflection light for each pixel of image data.

17. An image generation apparatus according to claim 8,
wherein the plurality of element data is four element data stored in one word,
the specific element data supplied to the multiplication means is one element data calculated from three element data of specular reflection light for each pixel of image data, and
three element data excluding the specific element data supplied to the subtraction means and the addition means is three element data of diffuse reflection light for each pixel of image data.

18. An image generation apparatus in which color information of a pixel of display output image is calculated using color information obtained from a texture image for each pixel of polygon image data, the apparatus comprising:
a first circuit for extracting a texture color to be attached to each point in the polygon based on vertex coordinates, texture coordinates, and texture information;
a second circuit for obtaining a shading color of each point in the polygon based on the vertex coordinates and vertex color information; and
a third circuit for obtaining an output color by entering the texture information from the first circuit and the shading color information from the second circuit,
wherein the third circuit includes: multiplication means for outputting modulated color information produced by multiplying the texture color information and one specific element data out of the plurality of element data included in the shading color information; and
addition means for adding, for each element, element data excluding the specific element data out of the plurality of element data and the modulated color information by the multiplication means.

19. An image generation apparatus according to claim 18,
wherein the specific element data supplied to the multiplication means is one element data indicating brightness information for each pixel of image data, and
the element data excluding the specific element data supplied to the addition means is element data indicating color information for each pixel of image data.

20. An image generation apparatus according to claim 18,
wherein the specific element data supplied to the multiplication means is one element data calculated from element data of diffuse reflection light for each pixel of image data, and
the element data excluding the specific element data supplied to the addition means is element data of specular reflection light for each pixel of image data.

21. An image generation apparatus according to claim 18,
wherein the specific element data supplied to the multiplication means is one element data calculated from element data of specular reflection light for each pixel of image data, and
the element data excluding the specific element data supplied to the addition means-is element data of diffuse reflection light for each pixel of image data.

22. An image generation apparatus in which color information of pixel of display output image is calculated using color information obtained from a texture image for each pixel of polygon image data, the apparatus comprising:
a first circuit for extracting a texture color to be attached to each point in the polygon based on vertex information, texture coordinates, and texture information;
a second circuit for obtaining shading color of each point in the polygon based on vertex coordinates and vertex color information; and
a third circuit for obtaining output color by entering the texture information from the first circuit and the shading color information from the second circuit,
wherein the third circuit includes: subtraction means for outputting first modulated color information produced by subtracting, for each element, element data excluding one specific element data included in the shading color information from the texture color information;
multiplication means for outputting second modulated color information produced by multiplying the first modulated color information by the specific element data included in the shading color information; and
addition means for adding, for each element, element data excluding the specific element data out of the plurality of element data included in the texture information or the shading information, and the second modulated color information by the multiplication means.

23. An image generation apparatus according to claim 22,
wherein the third circuit further including:
selection means for selecting either element data excluding the specific element data out of the plurality of element data, or element data excluding the specific element data having all zero element in order to be supplied to the subtraction means.

24. An image generation apparatus according to claim 22,
wherein the specific element data supplied to the multiplication means is element data which indicates mixture ratio for each pixel of the image data, and
element data excluding the specific element supplied to the subtraction means and the addition means is element data which indicates color information for each pixel of the image data.

25. An image generation apparatus according to claim 22,
wherein the specific element data supplied to the multiplication means is element data which indicates brightness information for each pixel of the image data, and
element data excluding the specific element supplied to the subtraction means and the addition means is element data which indicates color information for each pixel of the image data.

26. An image generation apparatus according to claim 22,
wherein the specific element data supplied to the multiplication means is one element data calculated from element data of the diffuse reflection light for each pixel of the image data, and
element data excluding the specific element supplied to the subtraction means and the addition means is element data of specular reflection light for each pixel of the image data.

27. An image generation apparatus according to claim 22,
wherein the specific element data supplied to the multiplication means is one element data calculated from element data of the specular reflection light for each pixel of the image data, and
element data excluding the specific element supplied to the subtraction means and the addition means is element data of the diffuse reflection light for each pixel of the image data.

28. An image generation apparatus in which color information of pixel of display output image is calculated using color information obtained from a texture image for each pixel of polygon image data, the apparatus comprising:
a first circuit for extracting a first texture color to be attached to each point in the polygon based on vertex coordinates, first texture coordinates, and first texture information;
a second circuit for obtaining a first shading color of each point in the polygon based on the vertex coordinates and the first vertex color information;
a third circuit for obtaining a second shading color by entering the first texture color information from the first circuit and the first shading color information from the second circuit;
a fourth circuit for extracting the second texture color to be attached to each point in the polygon based on the vertex coordinates, the second texture coordinates, and the second texture information; and
a fifth circuit for obtaining an output color by entering the second texture color information from the second circuit and the second shading color information from the third circuit,
wherein at least one of the third circuit and the fifth circuit includes: multiplication means for outputting modulated color information produced by multiplying the texture color information by one specific element data out of the plurality of element data included in the shading color information; and
addition means for adding, for each element, element data excluding the specific element data out of the plurality of element data and modulated color information by the multiplication means.

29. An image generation apparatus according to claim 28,
wherein the specific element data supplied to the multiplication means is one element data indicating brightness information for each pixel of image data, and
element data excluding the specific element data supplied to the addition means is element data indicating color information for each pixel of image data.

30. An image generation apparatus according to claim 28,
wherein the specific element data supplied to the multiplication means is one element data calculated from element data of diffuse reflection light for each pixel of image data, and
element data excluding the specific element data supplied to the addition means is element data of specular reflection light for each pixel of image data.

31. An image generation apparatus according to claim 28,
wherein the specific element data supplied to the multiplication means is one element data calculated from element data of specular reflection light for each pixel of image data, and
element data excluding the specific element data supplied to the addition means is element data of diffuse reflection light for each pixel of image data.

32. An image generation apparatus in which color information of pixel of display output image is calculated using color information obtained from a texture image for each pixel of polygon image data, the apparatus comprising:
a first circuit for extracting a first texture color to be attached to each point in the polygon based on vertex coordinates, first texture coordinates, and first texture information;
a second circuit for obtaining a first shading color of each point in the polygon based on the vertex coordinates and the first vertex color information;
a third circuit for obtaining second shading color by entering the first texture color information from the first circuit and the first shading color information from the second circuit;
a fourth circuit for extracting the second texture color to be attached to each point in the polygon based on the vertex coordinates, the second texture coordinates, and the second texture information; and
a fifth circuit for obtaining output color by entering the second texture color information from the second circuit and the second shading color information from the third circuit,
wherein at least one of the third circuit and the fifth circuit includes: subtraction means for outputting first modulated color information produced by subtracting, for each element, element data excluding one specific element data included in the shading color information from the texture color information;
multiplication means for outputting second modulated color information produced by multiplying the first modulated color information by the specific element data included in the shading color information; and
addition means for adding, for each element, element data excluding the specific element data out of the plurality of element data included in the texture information or the shading information, and the second modulated color information by the multiplication means.

33. An image generation apparatus according to claim 32,
wherein the third circuit, the fifth circuit, or both circuits further including:
selection means for selecting either the element data excluding the specific element data out of the plurality of element data, or the element data excluding the specific element data having all zero element in order to be supplied to the subtraction means.

34. An image generation apparatus according to claim 32,
wherein the specific element data supplied to the multiplication means is element data which indicates mixture ratio for each pixel of the image data, and
element data excluding the specific element supplied to the subtraction means and the addition means is element data which indicates color information for each pixel of the image data.

35. An image generation apparatus according to claim 32,
wherein the specific element data supplied to the multiplication means is element data which indicates brightness information for each pixel of the image data, and
element data excluding the specific element supplied to the subtraction means and the addition means is element data which indicates color information for each pixel of the image data.

36. An image generation apparatus according to claim 32,
wherein the specific element data supplied to the multiplication means is one element data calculated from element data of the diffuse reflection light for each pixel of the image data, and
element data excluding the specific element supplied to the subtraction means and the addition means is element data of specular reflection light for each pixel of the image data.

37. An image generation apparatus according to claim 32,
wherein the specific element data supplied to the multiplication means is one element data calculated from element data of the specular reflection light for each pixel of the image data, and
element data excluding the specific element supplied to the subtraction means and the addition means is element data of the diffuse reflection light for each pixel of the image data.

38. A method of generating image in which color information is obtained from a texture image for each pixel of image data, and color information of a pixel of display output image is calculated using the obtained color information, the method comprising:
a first step for dividing a plurality of element data given to the pixel into one specific element data and element data excluding the specific element data;
a second step for obtaining modulated color information which is produced by multiplying the color information obtained from the texture image for the pixel and specific element data out of a plurality of element data given to the pixel; and
a third step for adding, for each element, modulated color information by the multiplication means to element data excluding the specific element data out of the plurality of element data.

39. A method of generating image according to claim 38,
wherein the specific element data is one element data indicating brightness information for each pixel of image data, and
element data excluding the specific element data supplied to the addition means is element data indicating color information for each pixel of image data.

40. A method of generating image according to claim 38,
wherein the specific element data is one element data calculated from element data of diffuse reflection light for each pixel of image data, and
the element data excluding the specific element data is element data of specular reflection light for each pixel of image data.

41. A method of generating image according to claim 38,
wherein the specific element data is one element data calculated from element data of specular reflection light for each pixel of image data, and
the element data excluding the specific element data is element data of diffuse reflection light for each pixel of image data.

42. A method of generating image in which color information is obtained from a texture image for each pixel of image data, and color information of pixels of display output image is calculated using the obtained color information, the method comprising:
a first step for dividing a plurality of element data given to the pixel into one specific element data and element data excluding the specific element data;
a second step for obtaining the first modulated color information which is produced by subtracting, for each element, element data excluding one specific element data obtained from color information obtained from the texture image;
a third step for obtaining the second modulated color information which is produced by the multiplication of the specific element data and the first modulated color information; and
a fourth step for adding, for each element, the second modulated color information and element data excluding the specific element data out of the plurality of element data.

43. A method of generating image according to claim 42,
wherein the specific element data is element data which indicates mixture ratio for each pixel of the image data, and
element data excluding the specific element is element data which indicates color information for each pixel of the image data.

44. A method of generating image according to claim 42,
wherein the specific element data is element data which indicates brightness information for each pixel of the image data, and
element data excluding the specific element is element data which indicates color information for each pixel of the image data.

45. A method of generating image according to claim 42,
wherein the specific element data is one element data calculated from element data of the diffuse reflection light for each pixel of the image data, and
element data excluding the specific element is element data of specular reflection light for each pixel of the image data.

46. A method of generating image according to claim 42,
wherein the specific element data is one element data calculated from element data of the specular reflection light for each pixel of the image data, and
element data excluding the specific element is element data of the diffuse reflection light for each pixel of the image data.
